(19) United States
(12) Patent Application Publication
(10) Pub. No.: US 2023/0325004 A1
(43) Pub. Date: Oct. 12, 2023

(54) METHOD OF INTERACTING WITH OBJECTS IN AN ENVIRONMENT

(71) Applicant: Apple Inc., Cupertino, CA (US)

(72) Inventors: Aaron M. BURNS, Sunnyvale, CA (US); Alexis H. PALANGIE, Palo Alto, CA (US); Nathan GITTER, Cupertino, CA (US); Nicolai GEORG, San Francisco, CA (US); Benjamin R. BLACHNITZKY, San Francisco, CA (US); Arun Rakesh YOGANANDAN, San Francisco, CA (US); Benjamin HYLAK, Sunnyvale, CA (US); Adam G. POULOS, Saratoga, CA (US)

(21) Appl. No.: 18/182,300

(22) Filed: Mar. 10, 2023

Related U.S. Application Data
(63) Continuation of application No. PCT/US2021/049131, filed on Sep. 3, 2021.
(60) Provisional application No. 63/077,472, filed on Sep. 11, 2020.

(51) Int. Cl. G06F 3/01; G06F 3/0481

(52) U.S. Cl. CPC G06F 3/017; G06F 3/0481; G06F 3/013

(57) ABSTRACT

Methods for interacting with objects and user interface elements in a computer-generated environment provide for an efficient and intuitive user experience. In some embodiments, a user can directly or indirectly interact with objects. In some embodiments, while performing an indirect manipulation, manipulations of virtual objects are scaled. In some embodiments, while performing a direct manipulation, manipulations of virtual objects are not scaled. In some embodiments, an object can be reconfigured from an indirect manipulation mode into a direct manipulation mode by moving the object to a respective position in the three-dimensional environment in response to a respective gesture.

### CROSS-REFERENCE TO RELATED APPLICATIONS

This application is a continuation of International Application No. PCT/US2021/049131, filed Sep. 3, 2021, which claims the benefit of U.S. Provisional Application No. 63/077,472, filed Sep. 11, 2020, the contents of which are incorporated herein by reference in their entireties for all purposes.

### FIELD OF THE DISCLOSURE

This relates generally to methods for interacting with objects in a computer-generated environment.

### BACKGROUND OF THE DISCLOSURE

Computer-generated environments are environments where at least some objects displayed for a user's viewing are generated using a computer. Users may interact with objects displayed in a computer-generated environment, such as by moving the objects, rotating the objects, etc.

### SUMMARY OF THE DISCLOSURE

Some embodiments described in this disclosure are directed to methods of interacting with virtual objects in a computer-generated environment. Some embodiments described in this disclosure are directed to methods of performing direct and indirect manipulation of virtual objects. These interactions provide a more efficient and intuitive user experience. The full descriptions of the embodiments are provided in the Drawings and the Detailed Description, and it is understood that this Summary does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an electronic device displaying a computer-generated environment according to some embodiments of the disclosure.

FIGS. 2A-2B illustrate block diagrams of exemplary architectures for a device or devices in accordance with some embodiments of the disclosure.

FIG. 3 illustrates a method of displaying a three-dimensional environment with one or more virtual objects according to some embodiments of the disclosure.

FIGS. 4A-4D illustrate a method of indirectly manipulating a virtual object according to some embodiments of the disclosure.

FIGS. 5A-5D illustrate a method of directly manipulating a virtual object according to some embodiments of the disclosure.

FIGS. 6A-6B illustrate a method of moving a virtual object according to some embodiments of the disclosure.

FIG. 7 is a flow diagram illustrating a method of manipulating a virtual object according to some embodiments of the disclosure.

FIG. 8 is a flow diagram illustrating a method of moving a virtual object by an amount based on the distance of the virtual object to the user according to some embodiments of the disclosure

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. An XR environment is often referred to herein as a computer-generated environment. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic devices can enable a user to interact with and/or sense an XR environment. A non-exclusive list of examples include heads-up displays (HUDs), head mountable devices, projection-based devices, windows or vehicle windshields having integrated display capability, displays formed as lenses to be placed on users' eyes (e.g., contact lenses), headphones/earphones, input devices with or without haptic feedback (e.g., wearable or handheld controllers), speaker arrays, smartphones, tablets, and desktop/laptop computers. A head mountable device can have one or more speaker(s) and an opaque display. Other head mountable devices can be configured to accept an opaque external display (e.g., a smartphone). The head mountable device can include one or more image sensors to capture images/video of the physical environment and/or one or more microphones to capture audio of the physical environment. A head mountable device may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based devices can utilize retinal projection technology that projects images onto users' retinas. Projection devices can also project virtual objects into the physical environment (e.g., as a hologram or onto a physical surface).

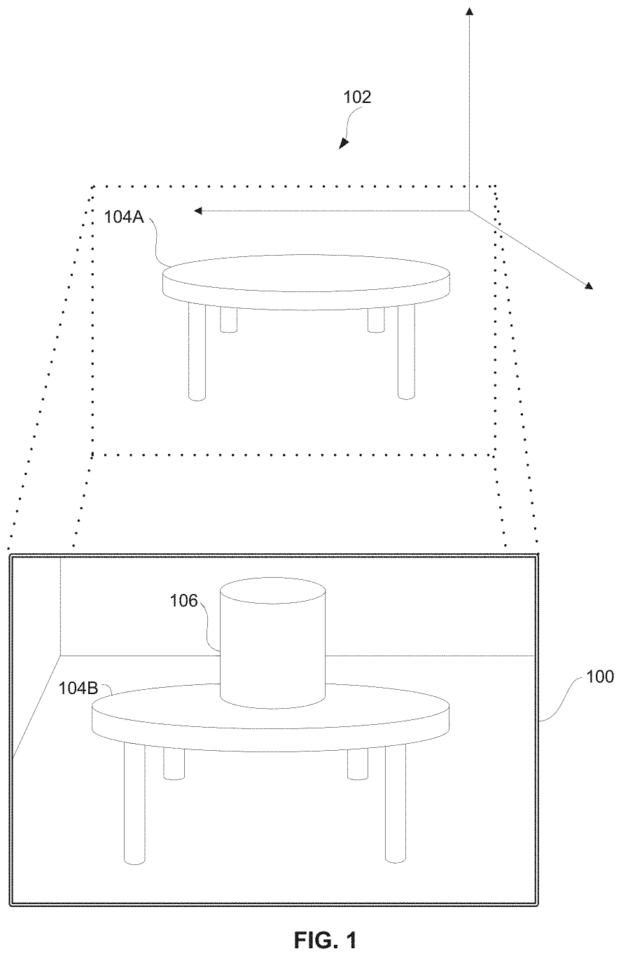

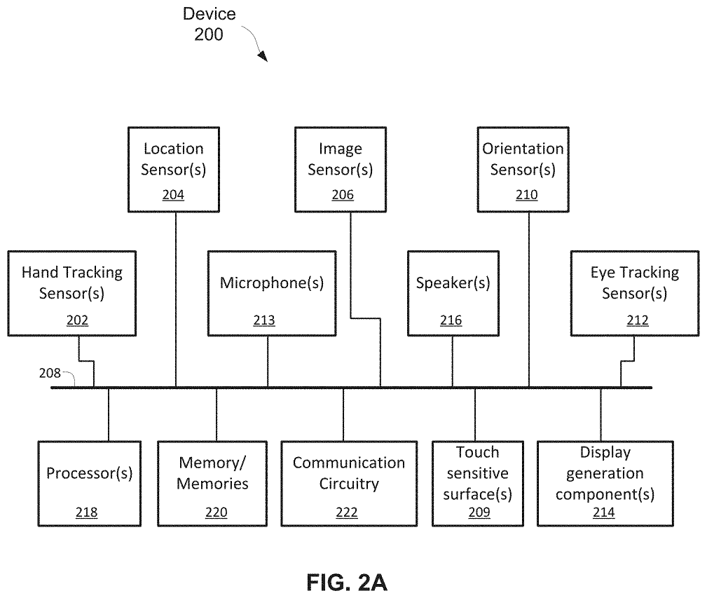

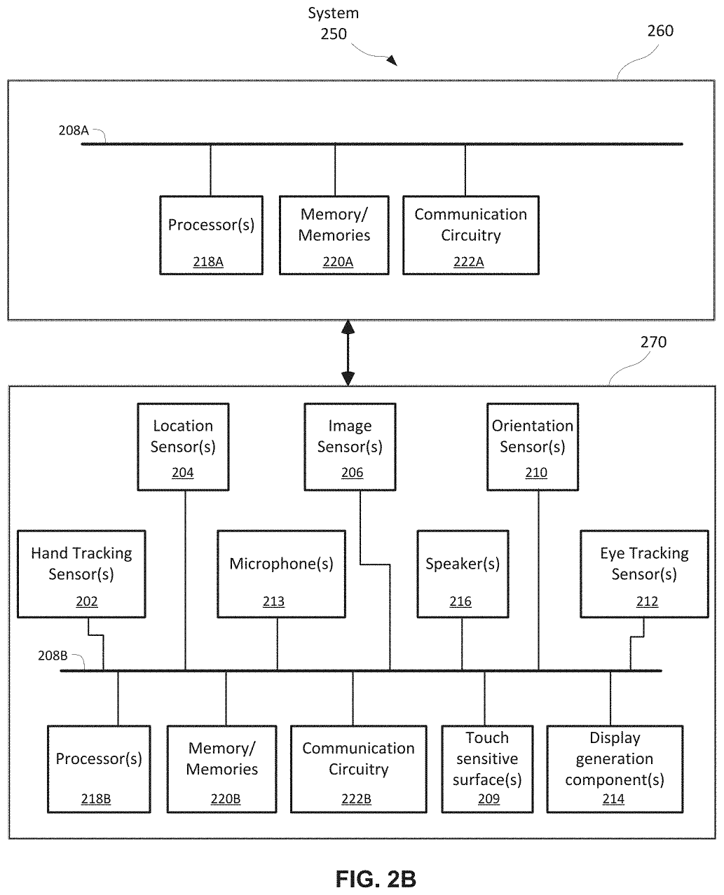

FIG. 1 illustrates an electronic device 100 configurable to display a computer-generated environment according to some embodiments of the disclosure. In some embodiments, electronic device 100 is a portable electronic device, such as a tablet computer, laptop computer or a smartphone, among other possibilities. Example architectures of electronic device 100 are described in further detail with reference to FIGS. 2A-2B. FIG. 1 illustrates electronic device 100 and table 104A located in the physical environment 102. In some embodiments, electronic device 100 is configured to capture and/or display areas of physical environment 102 including table 104A (illustrated in the field of view of electronic device 100). In some embodiments, the electronic device 100 is configured to display one or more virtual objects in the computer-generated environment that are not present in the physical environment 102, but are displayed in the computer generated environment (e.g., positioned on or otherwise anchored to the top surface of a computer-generated representation 104B of real-world table 104A). In FIG. 1, for example, an object 106 not present in the physical environment (e.g., a virtual object) is displayed on the surface of the table 104B in the computer-generated environment displayed via device 100, optionally in response to detecting the planar surface of table 104A in the physical environment 102. It should be understood that object 106 is a representative object and one or more different objects (e.g., of various dimensionality such as two-dimensional or three-dimensional objects) can be included and rendered in a two-dimensional or a three-dimensional computer-generated environment. For example, the virtual objects can include an application or a user interface displayed in the computer-generated environment. Additionally, it should be understood, that the three-dimensional (3D) environment (or 3D object) described herein may be a representation of a 3D environment (or 3D object) displayed in a two dimensional (2D) context (e.g., displayed on a 2D display screen).

FIGS. 2A-2B illustrate example block diagrams of architectures for a device or devices in accordance with some embodiments of the disclosure. The blocks in FIG. 2A can represent an information processing apparatus for use in a device. In some embodiments, device 200 is a portable device, such as a mobile phone, smart phone, a tablet computer, a laptop computer, an auxiliary device in communication with another device, etc. As illustrated in FIG. 2A, device 200 optionally includes various sensors (e.g., one or more hand tracking sensor(s) 202, one or more location sensor(s) 204, one or more image sensor(s) 206, one or more touch-sensitive surface(s) 209, one or more motion and/or orientation sensor(s) 210, one or more eye tracking sensor(s) 212, one or more microphone(s) 213 or other audio sensors, etc.), one or more display generation component(s) 214, one or more speaker(s) 216, one or more processor(s) 218, one or more memories 220, and/or communication circuitry 222. One or more communication buses 208 are optionally used for communication between the above mentioned components of device 200.

Communication circuitry 222 optionally includes circuitry for communicating with electronic devices, networks, such as the Internet, intranets, a wired network and/or a wireless network, cellular networks and wireless local area networks (LANs). Communication circuitry 222 optionally includes circuitry for communicating using near-field communication (NFC) and/or short-range communication, such as Bluetooth®.

Processor(s) 218 optionally include one or more general purpose processors, one or more graphics processors, and/or one or more digital signal processors (DSPs). In some embodiments, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some embodiments, memories 220 include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

Display generation component(s) 214 optionally include a single display (e.g., a liquid-crystal display (LCD), organic light-emitting diode (OLED), or other types of display). In some embodiments, display generation component(s) 214 include multiple displays. In some embodiments, display generation component(s) 214 includes a display with a touch-sensitive surface (e.g., a touch screen), a projector, a holographic projector, a retinal projector, etc.

In some embodiments, device 200 includes touch-sensitive surface(s) 209 configured to receive user inputs (touch and/or proximity inputs), such as tap inputs and swipe inputs or other gestures. In some embodiments, display generation component(s) 214 and touch-sensitive surface(s) 209 together form touch-sensitive display(s) (e.g., a touch screen integrated with device 200 or external to device 200 that is in communication with device 200). It should be understood, that device 200 optionally includes or receives input from one or more other physical user-interface devices than a touch-sensitive surface, such as a physical keyboard, a mouse, a stylus and/or a joystick (or any other suitable input device).

Image sensors(s) 206 optionally include one or more visible light image sensor, such as charged coupled device (CCD) sensors, and/or complementary metal-oxide-semiconductor (CMOS) sensors operable to obtain images of physical objects from the real-world environment. Image sensor(s) 206 optionally include one or more infrared (IR) or near infrared (NIR) sensors, such as a passive or an active IR or NIR sensor, for detecting infrared or near infrared light from the real-world environment. For example, an active IR sensor includes an IR emitter for emitting infrared light into the real-world environment. Image sensor(s) 206 optionally include one or more cameras configured to capture movement of physical objects in the real-world environment. Image sensor(s) 206 optionally include one or more depth sensors configured to detect the distance of physical objects from device 200. In some embodiments, information from one or more depth sensors can allow the device to identify and differentiate objects in the real-world environment from other objects in the real-world environment. In some embodiments, one or more depth sensors can allow the device to determine the texture and/or topography of objects in the real-world environment.

In some embodiments, device 200 uses CCD sensors, event cameras, and depth sensors in combination to detect the physical environment around device 200. In some embodiments, image sensor(s) 206 include a first image sensor and a second image sensor. The first image sensor and the second image sensor work together and are optionally configured to capture different information of physical objects in the real-world environment. In some embodiments, the first image sensor is a visible light image sensor and the second image sensor is a depth sensor. In some embodiments, device 200 uses image sensor(s) 206 to detect the position and orientation of device 200 and/or display generation component(s) 214 in the real-world environment. For example, device 200 uses image sensor(s) 206 to track the position and orientation of display generation component(s) 214 relative to one or more fixed objects in the real-world environment.

In some embodiments, device 200 optionally includes hand tracking sensor(s) 202 and/or eye tracking sensor(s) 212. Hand tracking sensor(s) 202 are configured to track the position/location of a user's hands and/or fingers, and/or motions of the user's hands and/or fingers with respect to the computer-generated environment, relative to the display generation component(s) 214, and/or relative to another coordinate system. Eye tracking sensor(s) 212 are configured to track the position and movement of a user's gaze (eyes, face, or head, more generally) with respect to the real-world or computer-generated environment and/or relative to the display generation component(s) 214. The user's gaze can include a direction in which the eyes are directed, and optionally intersection with a particular point or region of space and/or intersection with a particular object. In some embodiments, hand tracking sensor(s) 202 and/or eye tracking sensor(s) 212 are implemented together with the display generation component(s) 214 (e.g., in the same device). In some embodiments, the hand tracking sensor(s) 202 and/or eye tracking sensor(s) 212 are implemented separate from the display generation component(s) 214 (e.g., in a different device).

In some embodiments, the hand tracking sensor(s) 202 uses image sensor(s) 206 (e.g., one or more IR cameras, 3D cameras, depth cameras, etc.) that capture three-dimensional information from the real-world including one or more hands. In some examples, the hands can be resolved with sufficient resolution to distinguish fingers and their respective positions. In some embodiments, one or more image sensor(s) 206 are positioned relative to the user to define a field of view of the image sensor(s) and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures) can be advantageous in that it provides an input means that does not require the user to touch or hold input device, and using image sensors allows for tracking without requiring the user to wear a beacon or sensor, etc. on the hands/fingers.

In some embodiments, eye tracking sensor(s) 212 includes one or more eye tracking cameras (e.g., IR cameras) and/or illumination sources (e.g., IR light sources/LEDs) that emit light towards a user's eyes. Eye tracking cameras may be pointed towards a user's eyes to receive reflected light from the light sources directly or indirectly from the eyes. In some embodiments, both eyes are tracked separately by respective eye tracking cameras and illumination sources, and gaze can be determined from tracking both eyes. In some embodiments, one eye (e.g., a dominant eye) is tracked by a respective eye tracking camera/illumination source(s).

Device 200 optionally includes microphones(s) 213 or other audio sensors. Device 200 uses microphone(s) 213 to detect sound from the user and/or the real-world environment of the user. In some embodiments, microphone(s) 213 includes an array of microphones that optionally operate together (e.g., to identify ambient noise or to locate the source of sound in space of the real-world environment). In some embodiments, audio and/or voice inputs can be used to interact with the user interface or computer-generated environment captured using one or more audio sensors (e.g., microphones), as permitted by the user of the electronic device.

Device 200 optionally includes location sensor(s) 204 configured to detect a location of device 200 and/or of display generation component(s) 214. For example, location sensor(s) 204 optionally includes a GPS receiver that receives data from one or more satellites and allows device 200 to determine the device's absolute position in the physical world.

Device 200 optionally includes motion and/or orientation sensor(s) 210 configured to detect orientation and/or movement of device 200 and/or display generation component(s) 214. For example, device 200 uses orientation sensor(s) 210 to track changes in the position and/or orientation of device 200 and/or display generation component(s) 214 (e.g., with respect to physical objects in the real-world environment). Orientation sensor(s) 210 optionally include one or more gyroscopes, one or more accelerometers, and/or one or more inertial measurement units (IMUs).

It is understood that the architecture of FIG. 2A is an example architecture, but that device 200 is not limited to the components and configuration of FIG. 2A. For example, the device can include fewer, additional, or other components in the same or different configurations. In some embodiments, as illustrated in FIG. 2B, system 250 can be divided between multiple devices. For example, a first device 260 optionally includes processor(s) 218A, memory or memories 220A, and communication circuitry 222A, optionally communicating over communication bus(es) 208A. A second device 270 (e.g., corresponding to device 200) optionally includes various sensors (e.g., one or more hand tracking sensor(s) 202, one or more location sensor(s) 204, one or more image sensor(s) 206, one or more touch-sensitive surface(s) 209, one or more motion and/or orientation sensor(s) 210, one or more eye tracking sensor(s) 212, one or more microphone(s) 213 or other audio sensors, etc.), one or more display generation component(s) 214, one or more speaker(s) 216, one or more processor(s) 218B, one or more memories 220B, and/or communication circuitry 222B. One or more communication buses 208B are optionally used for communication between the above mentioned components of device 270. The details of the components for devices 260 and 270 are similar to the corresponding components discussed above with respect to device 200 and are not repeated here for brevity. First device 260 and second device 270 optionally communicate via a wired or wireless connection (e.g., via communication circuitry 222A-222B) between the two devices.

Device 200 or system 250 typically support a variety of applications that may be displayed in the computer-generated environment, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo/video management application, a digital camera application, a digital video camera application, a web browsing application, a digital music player application, a television channel browsing application, and/or a digital video player application.

A computer-generated environment may be displayed using an electronic device (e.g., electronic device 100, device 200, device 270), including using one or more display generation components. The computer-generated environment can optionally include various graphical user interfaces (“GUIs”) and/or user interface objects.

In some embodiments, the electronic device can detect or estimate a lighting characteristic of the real world. The estimate of the lighting characteristic can provide some understanding of lighting in the environment. For example, the estimate of the lighting characteristic may provide an indication of which regions of the real-world environment are light or dark. The estimate of the lighting characteristic may provide an indication of the position of light sources (e.g., parametric light sources, directional light sources, point light sources, area light sources, etc.) and/or orientation of light sources. In some embodiments, the lighting characteristic is estimated as a per-voxel incident light field indicating brightness, color and/or direction. For example, the lighting characteristic can be parameterized as an image-based lighting (IBL) environment map. It should be understood that other parameterizations of the lighting characteristic are possible. In some examples, the lighting characteristic is estimated on a per pixel basis of using a triangle mesh with the lighting characteristic defining lighting for each vertex or for each face. Additionally, it should be understood that the estimate of the lighting characteristic is optionally derived from an intermediate representation (e.g., environment map).

In some embodiments, sensors such as cameras (e.g., image sensor(s) 206) are used to capture images of the real-world environment. The images can be processed by processing circuitry (one or more of processor(s) 218) to localize and measure light sources. In some embodiments, light can be determined from the reflections and or shadows cast by light sources in the environment. In some embodiments, deep learning (e.g., supervised) or other artificial intelligence or machine learning is used to estimate the lighting characteristic based on input image(s).

As described herein, a computer-generated environment including various graphics user interfaces (“GUIs”) may be displayed using an electronic device, such as electronic device 100 or device 200, including one or more display generation components. The computer-generated environment can include one or more virtual objects. In some embodiments, the one or more virtual objects can be interacted with or manipulated within the three-dimensional environment. For example, a user is able to move or rotate a virtual object. As will be described in further detail below, interactions with a virtual object can be either direct or indirect and the device can automatically interpret user inputs as either a direct or indirect manipulation based on the context, such as the position of the hands of the user and/or the position of the virtual object to be manipulated.

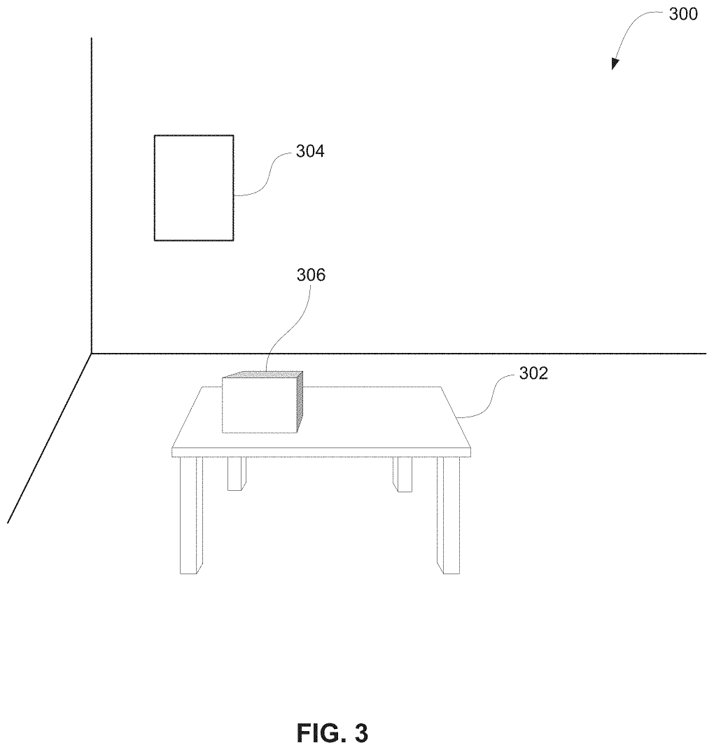

FIG. 3 illustrates a method of displaying a three-dimensional environment 300 with one or more virtual objects according to some embodiments of the disclosure. In FIG. 3A, an electronic device (e.g., such as devices 100 or 200 described above) is displaying a three-dimensional environment 300. In some embodiments, three-dimensional environment 300 includes one or more real-world objects (e.g., representations of objects in the physical environment around the device) and/or one or more virtual objects (e.g., representations of objects generated and displayed by the device that are not necessarily based on real world objects in the physical environment around the device). For example, in FIG. 3A, table 302 and picture frame 304 can be representations of real world objects in the physical environment around the device. In some embodiments, table 302 and picture frame 304 are displayed by the display generation component by capturing one or more images of table 302 and picture frame 304 (e.g., in the physical environment around the device) and displaying a representation of the table and picture frame (e.g., a photorealistic representation, a simplified representation, a caricature, etc.), respectively, in three-dimensional environment 300. In some embodiments, table 302 and picture frame 304 are passively provided by the device via a transparent or translucent display by not obscuring the user's view of table 302 and picture frame 304. In FIG. 3A, cube 306 is a virtual object and is displayed in three-dimensional environment 300 on top of table 302 and does not exist in the physical environment around the device. In some embodiments, virtual devices can interact with representations of real-world objects in both the case where the representations of real world objects are actively displayed by the device and passively displayed by the device, such as cube 306 being displayed as being placed on the top of table 302 in FIG. 3.

In some embodiments, table 302 and picture frame 304 are representations of real-world objects in the environment around the device and thus may not be manipulated by the user via the device. For example, because table 302 exists in the physical environment around the device, to move or otherwise manipulate table 302, a user could physically move or manipulate table 302 in the physical environment around the device to cause table 302 to be moved or manipulated in three-dimensional environment 300. By contrast, because cube 306 is a virtual object, cube 306 can be manipulated by a user of the device via the device (e.g., without requiring the user to manipulate objects in the physical world around the device), as will be described in further detail below.

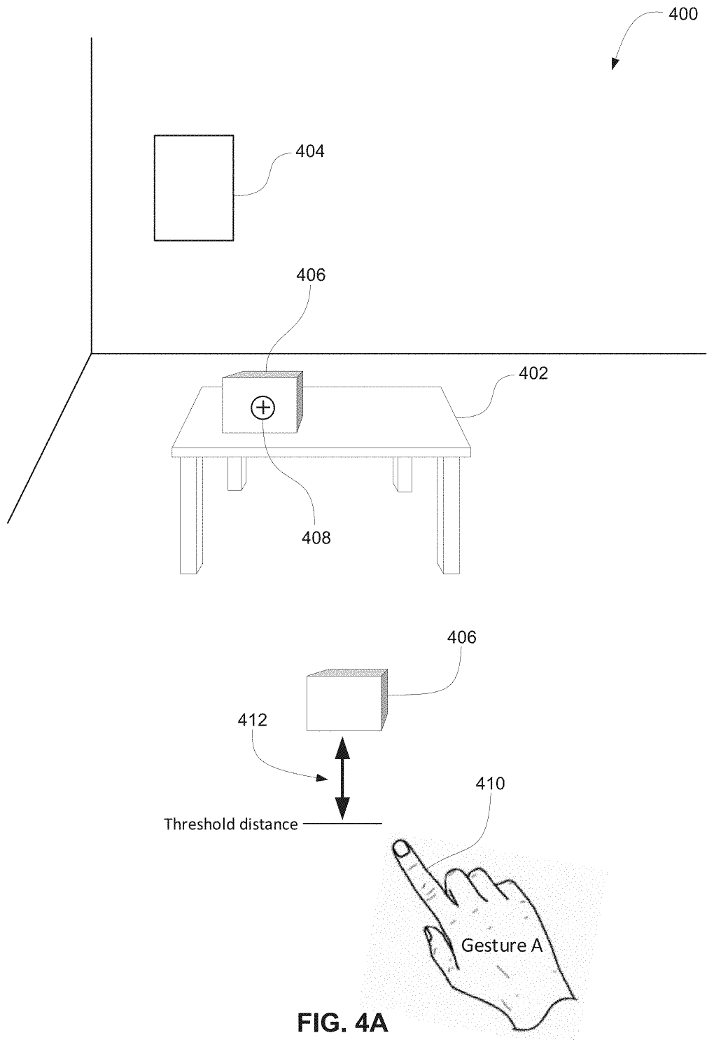

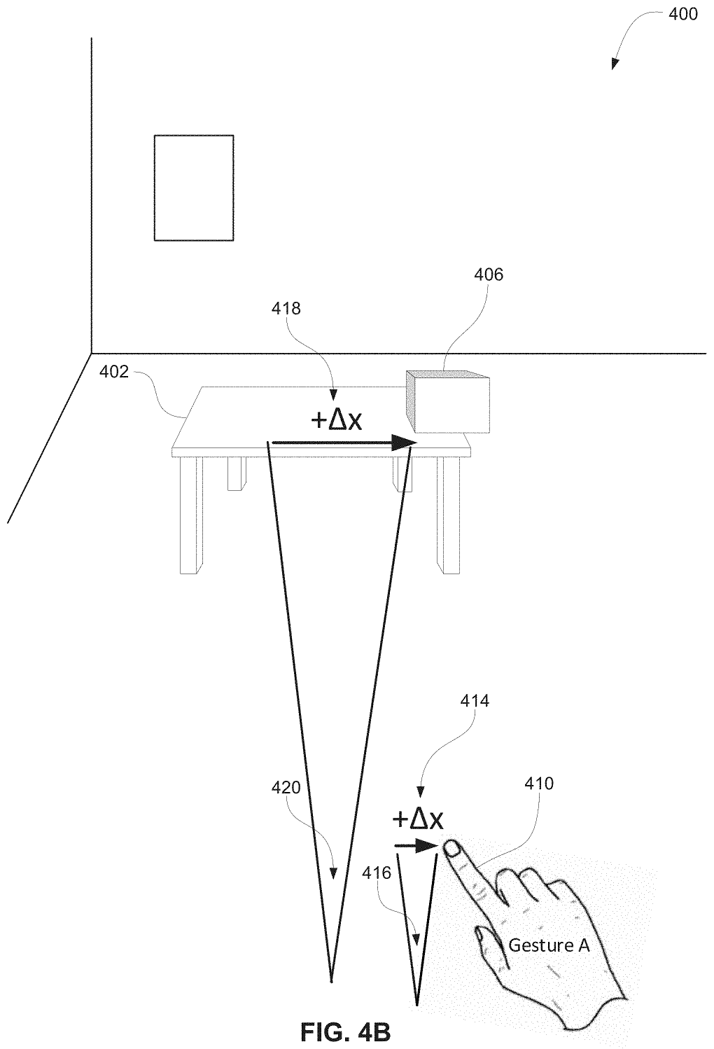

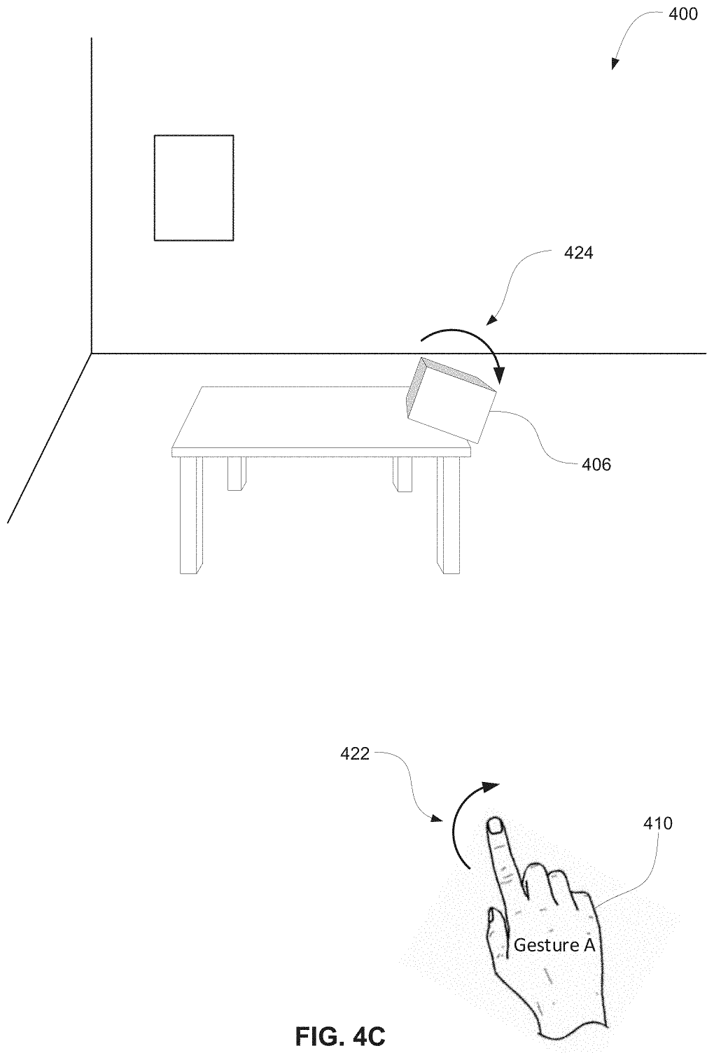

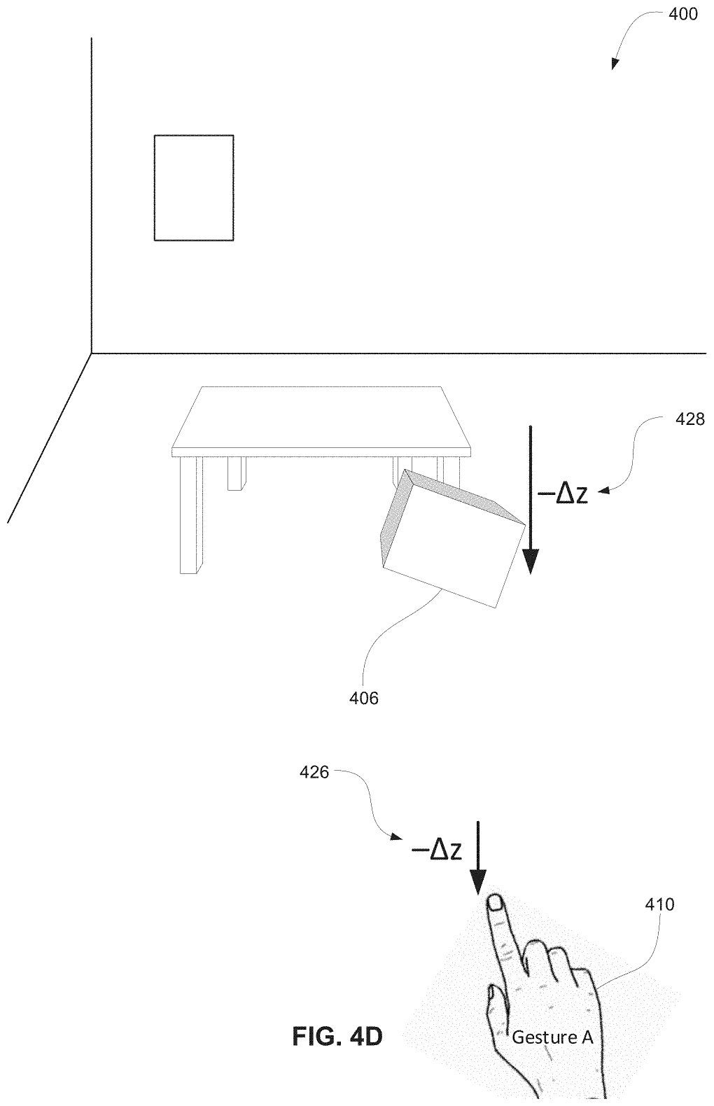

FIGS. 4A-4D illustrate a method of indirectly manipulating a virtual object according to some embodiments of the disclosure. In FIG. 4A, the device (e.g., device 100 or device 200) displays three-dimensional environment 400 (e.g., similar to three-dimensional environment 300) via a display generation component, including cube 406 on table 402. In some embodiments, cube 406 is a virtual object similar to cube 306 described above with respect to FIG. 3. FIG. 4A illustrates cube 406 twice, but it is understood that the second cube 406 that is displayed near the bottom of the figure (e.g., near hand 410) is not displayed in three-dimensional environment 400 and is shown in FIG. 4A for the purpose of illustrating the distance of hand 410 from cube 406 (e.g., on table 402) when performing Gesture A, as will be described in further detail below. In other words, three-dimensional environment 400 does not include two copies of cube 406 (e.g., the second cube 406 near hand 410 is a duplicate of cube 406 on table 402 and is displayed for illustration purposes, and the duplicate is not illustrated in FIGS. 4B-4D).

In FIG. 4A, hand 410 is the hand of the user of the device and the device is able to track the position and/or detect gestures performed by hand 410 (e.g., via one or more hand tracking sensors). In some embodiments, a representation of hand 410 is displayed in three-dimensional environment 400, for example, if hand 410 is held in front of the device, the device can capture an image of hand 410 and display a representation of hand 410 at a corresponding location in the three-dimensional environment (or passively provide visibility of hand 410). In other embodiments, hand 410 may be a real world object in the physical environment that is passively provided by the device via a transparent or translucent display by not obscuring the user's view of the hand. As used herein, reference to a physical object such as hand can refer to either a representation of that physical object presented on a display, or the physical object itself as passively provided by a transparent or translucent display. Thus, as the user moves hand 410, a representation of hand 410 moves in three-dimensional environment 400 accordingly.

In some embodiments, a user is able to use hand 410 to interact with virtual objects in three-dimensional environment 400 as if the user were interacting with real world objects in the physical environment around the device. In some embodiments, a user's interaction with a virtual object can be referred to as either a direct manipulation interaction or an indirect manipulation interaction. In some embodiments, direct manipulation interactions include interactions in which the user uses one or more hands to intersect with a virtual object (or come within a threshold distance of a virtual object) to directly manipulate the virtual object. In some embodiments, indirect manipulation interactions include interactions in which a user uses one or more hands to manipulate a virtual object without the one or more hands intersecting the virtual object (or coming within the threshold distance of the virtual object).

Returning to FIG. 4A, the device detects that hand 410 is performing a first gesture (e.g., “Gesture A”) corresponding to a selection input (e.g., via one or more hand tracking sensors) while gaze 408 is directed at virtual object (e.g., cube 406). In some embodiments, gaze 408 is detected via one or more eye tracking sensors and is able to determine the location or objects that the user's eyes are looking at or toward. In FIG. 4A, when hand 410 performs the first gesture, hand 410 is farther than threshold distance 412 from cube 406.

In some embodiments, the distance between hand 410 and cube 406 is determined based on the distance between the location of hand 410 in the physical world and the corresponding location of cube 406 on table 402 in the physical world. For example, cube 406 is displayed at a location in three-dimensional environment 400 that has a corresponding location in the physical world, and the distance between the corresponding location of cube 406 in the physical world and the location of hand 410 of the user in the physical world is used to determine whether hand 410 is farther than threshold distance 412 from cube 406. In some embodiments, the distance can be determined based on the distance between the location of hand 410 in three-dimensional environment and cube 406 in three-dimensional environment 400. For example, a representation of hand 410 is displayed at a respective location in three-dimensional environment 400 and the distance between the respective position of hand 410 in three-dimensional environment 400 and the position of cube 406 in three-dimensional environment 400 is used to determine whether hand 410 is farther than threshold distance 412 from cube 406. For example, if hand 410 is held one foot in front of the user (e.g., has not reached towards cube 406), and the cube 406 is 6 feet away from the user, then hand 410 is determined to be five feet away from hand 410. In some embodiments, threshold distance 412 can be 1 inch, 3 inches, 6 inches, 1 foot, 3 feet, etc.

In some embodiments, the first gesture corresponding to a selection input can be a pinch gesture by two or more fingers or one or more hands of the user (e.g., a pinch between the thumb and forefinger of hand 410). In some embodiments, the first gesture corresponding to a selection input can be a pointing gesture or a tapping gesture by a finger of hand 410 (e.g., the forefinger of hand 410). In some embodiments, any other gesture that is predetermined to correspond to a selection input is possible.

In some embodiments, in accordance with a determination that the selection gesture (e.g., pinch gesture, “Gesture A”) is performed by hand 410 while hand 410 is more than threshold distance 412 from cube 406 (e.g., optionally more than threshold distance 412 from any virtual object), the device is configured in an indirect manipulation mode in which user inputs are directed to the virtual object that the user's gaze is directed to when inputs are received. For example, in FIG. 4A, gaze 408 is directed at cube 406 (e.g., looking at cube 406, focused on cube 406, etc.) when hand 410 performed the selection input. Thus, the selection input is performed on cube 406 (e.g., cube 406 is selected for manipulation). In some embodiments, cube 406 remains selected while hand 410 maintains the selection gesture. While cube 406 remains selected, manipulation gestures by hand 410 cause manipulation operations to be performed on cube 406 (e.g., optionally even if gaze 408 moves away from cube 406).

FIG. 4B illustrates a method of moving a virtual object in three-dimensional environment 400. In FIG. 4B, while maintaining the selection gesture, the device detects hand 410 moving rightwards (e.g., in the “x” axis) by a respective amount 414. In some embodiments, moving hand 410 rightwards by respective amount 414 corresponds to an angular movement of hand 410 by a respective angle 416. For example, to move hand 410 by respective amount 414, the user pivots the user's respective arm by respective angle 416. In some embodiments, respective angle 416 is the angle formed between a first ray that extends from the position of the device outwards to the previous position of the hand and a second ray that extends from the position of the device outwards to the new position of the hand.

In FIG. 4B, in response to detecting the rightward movement by hand 410 by respective amount 414 while maintaining the selection gesture, cube 406 is similarly moved rightwards (e.g., in the “x” axis) in three-dimensional environment 400 by a second respective amount 418. In some embodiments, second respective amount 418 is different from respective amount 414. In some embodiments, second respective amount 418 is the respective amount 414 scaled by a scaling factor. In some embodiments, the scaling factor is based on the distance of cube 406 from the user (e.g., the distance of cube 406 from the “camera” of three-dimensional environment 400, the distance of cube 406 from the location in three-dimensional environment 400 associated with the user, and/or the location from which the user is viewing three-dimensional environment 400). In some embodiments, the second respective amount 418 is calculated such that the angular change by cube 406 is the same as the angular change by hand 410. For example, the second respective angle 420 (e.g., the angle formed between a first ray that extend from the position of the device outwards to the previous position of cube 406 and a second ray that extends from the position of the device outwards to the new position of cube 406) is equal to respective angle 416. Thus, in some embodiments, the scaling factor for the second respective amount 414 is calculated based on the distance of cube 406 from the user and the distance of hand 410 from the user (e.g., a ratio of the two distances).

In some embodiments, as will be described in further detail below, the movement of cube 406 can move in any direction based on the movement of hand 410 (e.g., cube 406 exhibits six degrees of freedom). In some embodiments, the movement of cube 406 can lock into one dimension based on the movement of hand 410. For example, if the initial movement of hand 410 is in the x direction (e.g., the horizontal component of the movement of hand 410 is larger than the other movement components of the movement of hand 410, for the first 0.1 seconds, 0.3 seconds, 0.5 seconds, 1 second, or first 1 cm, 3 cm, 10 cm, or movement, etc.), then the movement of cube 406 locks into only horizontal movements (e.g., cube 406 only moves horizontally based on the horizontally component of the movement of cube 406, and will not move vertically or change depth, even if hand 410 includes vertical and/or depth movement components, and/or moves vertically and/or changes depth), until the selection input is terminated.

FIG. 4C illustrates a method of rotating a virtual object in three-dimensional environment 400. In FIG. 4C, while maintaining the selection gesture, the device detects the rotation of hand 410 by a respective amount 422. In some embodiments, the rotation of hand 410 is in the yaw orientation (e.g., clockwise such that the fingers are rotated rightwards with respect to the wrist and the wrist is rotated leftwards with respect to the fingers). In some embodiments, the rotation of hand 410 is in the roll orientation (e.g., the fingers and wrist maintain their respective positions with respect to each other but hand 410 is rotated to reveal portions of hand 410 that were previously facing the other direction (e.g., portions that were previously obscured and/or facing away from the device). In some embodiments, the rotation of hand 410 (e.g., in any orientation) that does not include a lateral movement (e.g., horizontal movement, vertical movement, or a change in depth) or includes a lateral movement of less than a threshold amount (e.g., less than 1 inch, less than 3 inches, less than 6 inches, less than 1 foot, etc.) is interpreted as a request to rotate cube 406.

In FIG. 4C, in response to detecting the rotation by hand 410 by respective amount 422 while maintaining the selection gesture, cube 406 is rotated in accordance with the rotation of hand 410 by a second respective amount 424. In some embodiments, cube 406 rotates in the same orientation as the rotation of hand 410. For example, if hand 410 rotated in the yaw orientation, then cube 406 rotates in the yaw orientation and if hand 410 rotates in a roll orientation, then cube 406 rotates in the roll orientation, etc. In some embodiments, the second respective amount 424 that cube 406 is rotated is the same as the respective amount 422 that hand 410 is rotated. For example, if hand 410 performed a 90 degree rotation, then cube 406 is rotated in the same direction by 90 degrees.

In some embodiments, the second respective amount 424 that cube 406 is rotated is different than the respective amount 422 of rotation by hand 410 (e.g., the rotation is dampened or amplified). For example, if cube 406 can only be rotated by 180 degrees (e.g., a property of cube 406 is that cube 406 cannot be upside down, for example), then the rotation of cube 406 may be scaled by half (e.g., a 90 degree rotation of hand 410 causes a 45 degree rotation of cube 406). In another example, if cube 406 can only be rotated by 180 degrees, then cube 406 rotates 180 degrees in response to a 180 degree rotation of hand 410, but then cube 406 either does not rotate in response to further rotation by hand 410 (e.g., beyond 180 degrees) or exhibits a rubberbanding effect or resistance to further rotation by hand 410 (e.g., cube 406 temporarily rotates beyond its maximum amount while hand 410 is continuing to rotate, but returns to its maximum rotation value when the rotation and/or input terminates).

FIG. 4D illustrates a method of moving a virtual object toward or away from the user in three-dimensional environment 400. In FIG. 4D, while maintaining the selection gesture, the device detects a movement of hand 410 by a respective amount 426 toward the user (e.g., pulling hand 410 back from an extended position towards the body of the user and/or towards the device). Thus, the distance between hand 410 and the device is reduced (e.g., a z-direction movement).

In FIG. 4D, in response to detecting the movement by hand 410 moving towards the user and/or device by respective amount 426 while maintaining the selection gesture, cube 406 is moved towards the user (e.g., closer to the “camera” of the three-dimensional environment 400) by a second respective amount 428. In some embodiments, the amount that cube 406 moves (e.g., second respective amount 428) is the same as the amount of movement by hand 410 (e.g., respective amount 426), optionally in the same direction as hand 410. In some embodiments, the amount that cube 406 moves (e.g., second respective amount 428) is different from the amount of movement by hand 410 (e.g., respective amount 426), optionally in the same direction as hand 410. In some embodiments, the amount that cube 406 moves is based on the distance of cube 406 from the user and/or the distance of hand 410 from the user. For example, if cube 406 is farther away from the user, then cube 406 moves by more than if cube 406 is closer to the user, in response to the same amount of movement by hand 410. For example, if hand 410 moved towards the user (e.g., towards the device, towards the cameras of the device) by 6 inches, then if cube 406 is far away from the user, cube 406 can move closer by 2 feet but if cube 406 is close to the user, cube 406 can move closer by 6 inches.

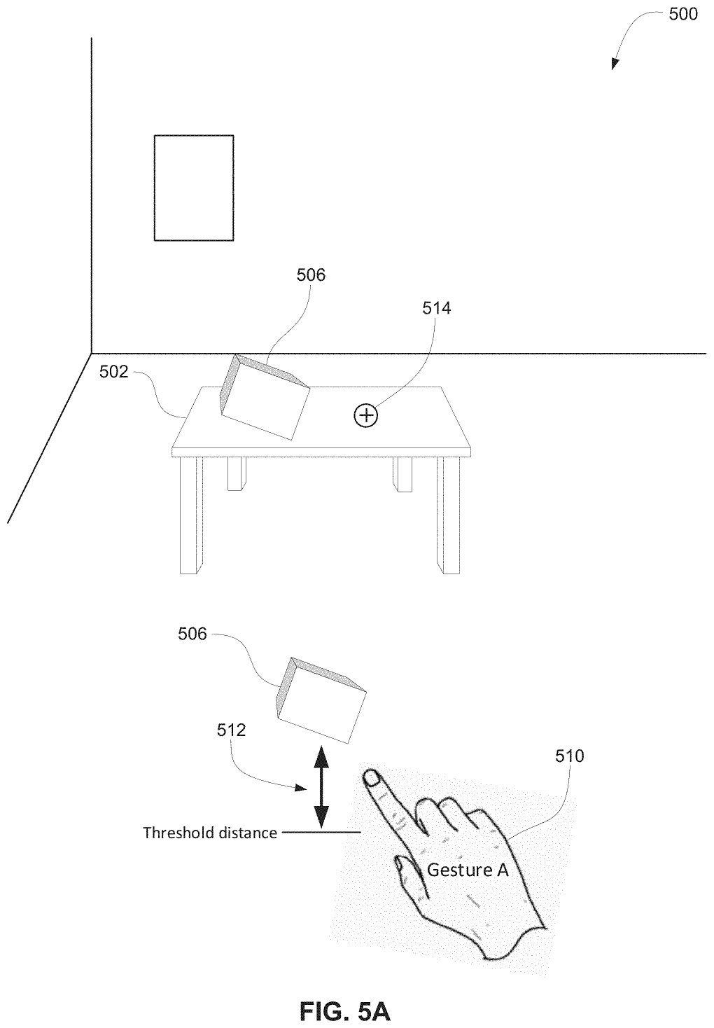

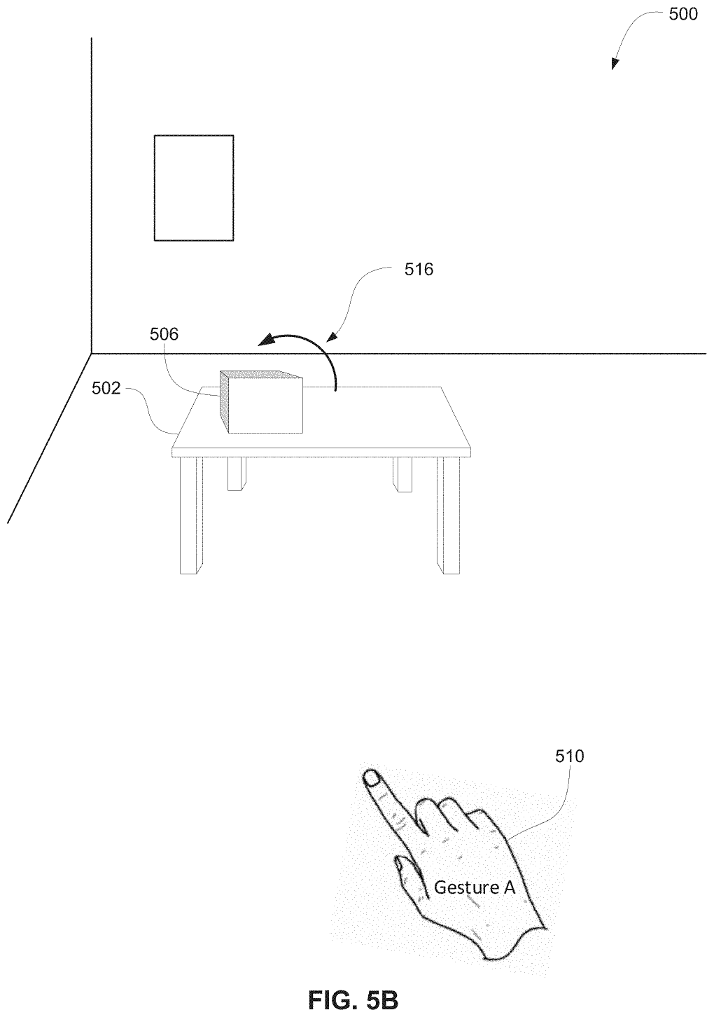

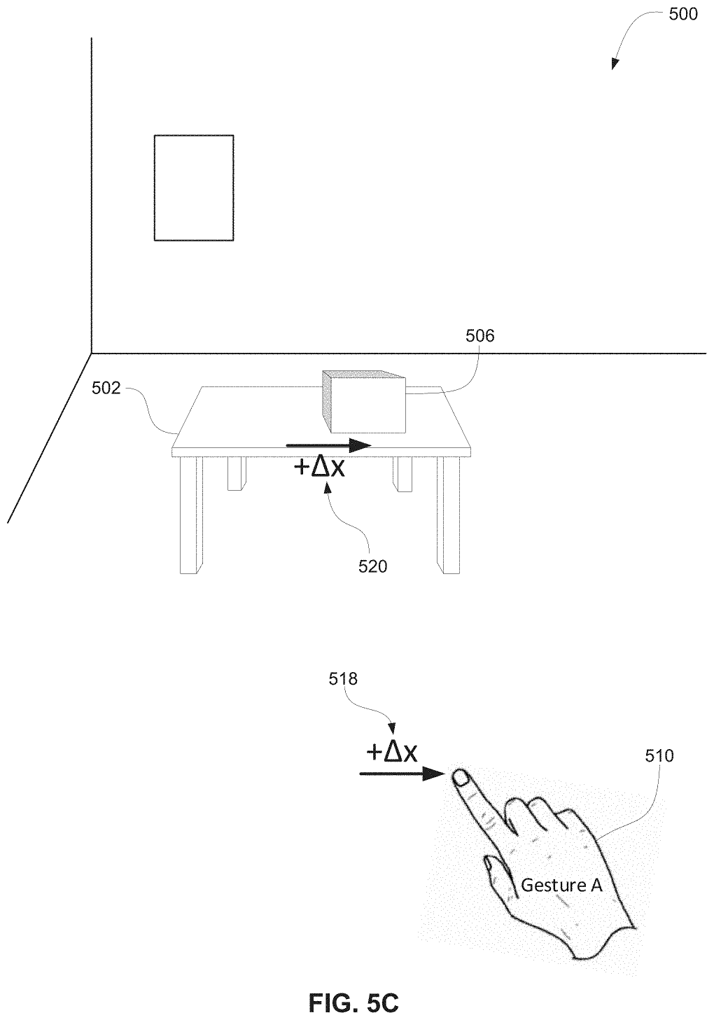

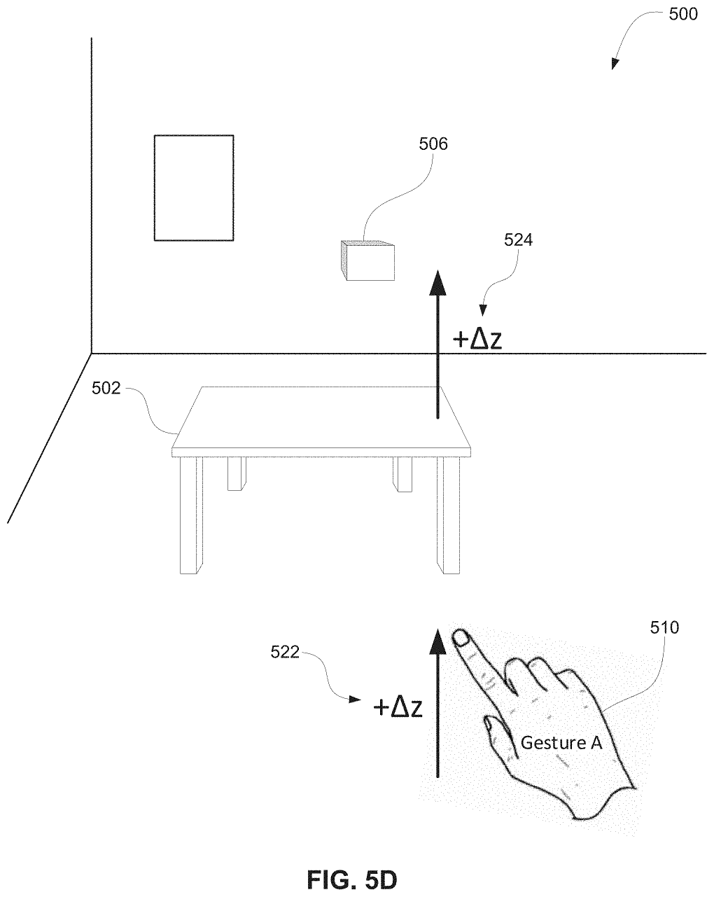

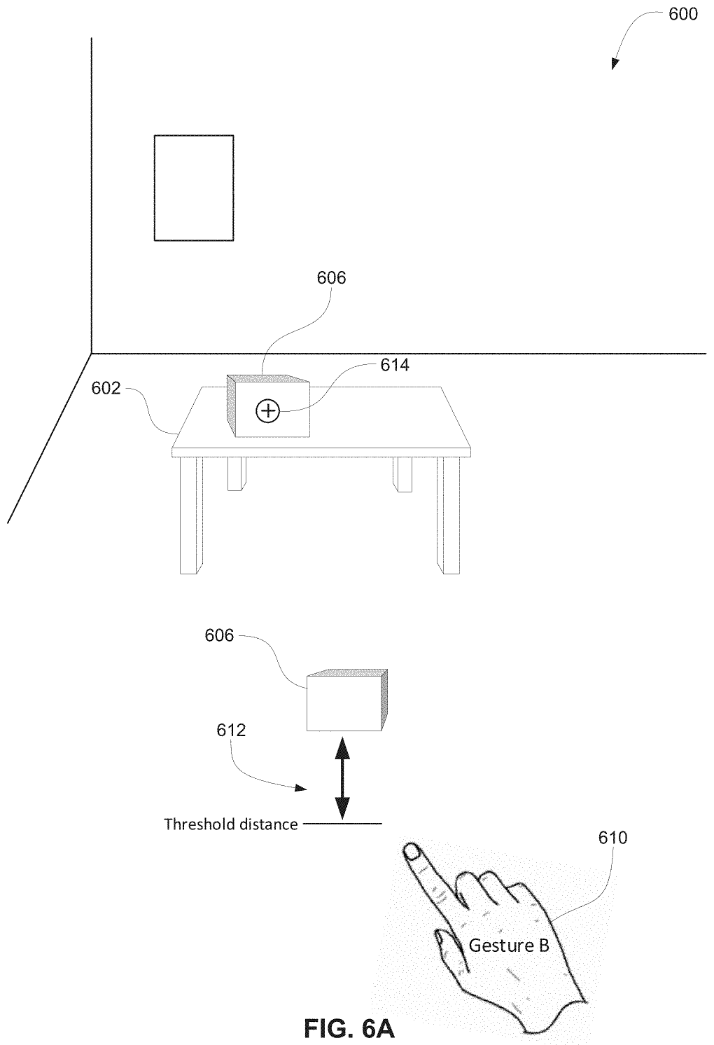

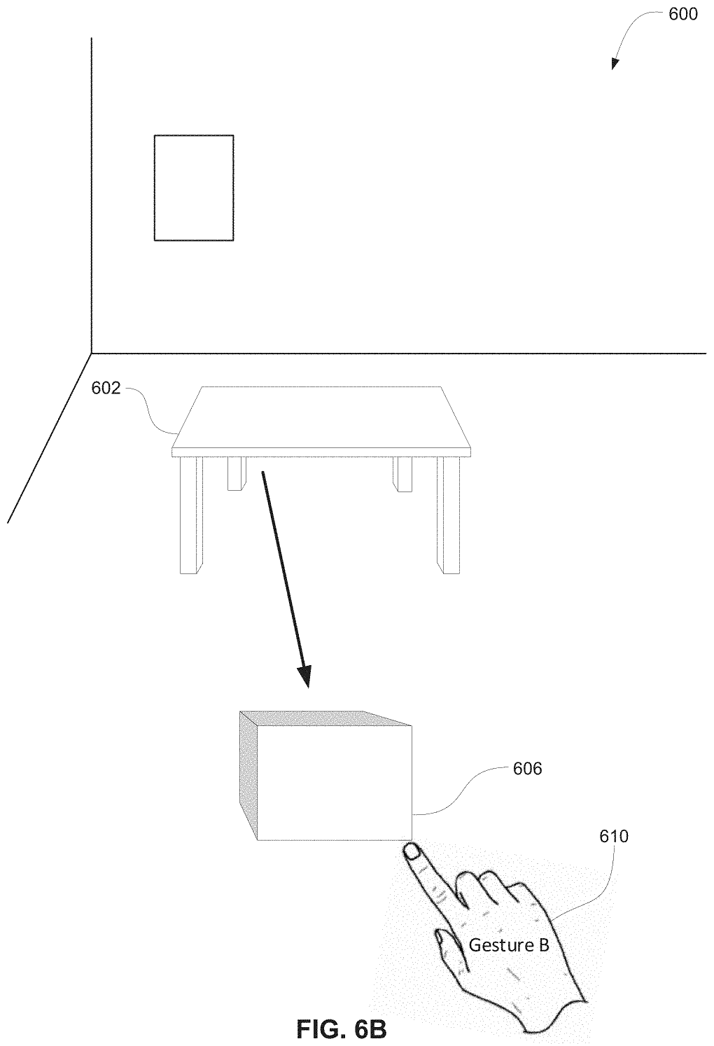

In some embodiments, the amount of movement by cube 406 is scaled based on a ratio between the distance that cube 406 is from the user and/or device and the distance that hand 410 is from the user and/or device when the selection input (e.g., pinch gesture) was initially received. For example, if hand 410 is two feet away from the user (e.g., two feet away from the eyes of the user, two feet away from the device, two feet away from the camera of the device), and cube 406 is ten feet away from the user (e.g., ten feet away from the eyes of the user ten two feet away from the device, ten feet away from the camera of the device) when the selection input was received, then the scaling factor is five (e.g., the distance of cube 406 divided by the distance of hand 410). Thus, a 1 inch movement of hand 410 in the z axis (e.g., towards the user or away from the user) causes a 5 inch movement of cube 406 in the same direction (e.g., towards the user or away from the user). Thus, cube 406 moves closer to the user as the user brings hand 410 closer to the user such that when hand 410 reaches the user, cube 406 also reaches the user. In this way, a user is able to use hand 410 to bring cube 406 from its initial position to the user, without requiring the user to perform the input multiple times. In some embodiments, cube 406 is brought to the location of the user. In some embodiments, cube 406 is brought to the location of hand 410, such that cube 406 is in contact with hand 410 or within a threshold distance of hand 410 (e.g., 1 inch, 3 inches, 6 inches, etc.). In some embodiments, when cube 406 is brought to the location of hand 410, the user is able to perform direct manipulations of cube 406 using hand 410, as will be described in further detail below with reference to FIGS. 5A-5D and 6A-6B.

In some embodiments, instead of scaling the movement based on the distance (e.g., of cube 406 and/or of hand 410) from the user, the movement is based on the distance (e.g., of cube 406 and/or of hand 410) from a location that is a predetermined distance in front of the user (e.g., a predetermined reference location that is optionally the location of the user or a location in front of the user). For example, the reference location can be the location of the user, the location of the face of the user, the location of the device (e.g., as described above), or 3 inches in front of the user (or face of the user, or device), 6 inches in front of the user (or face of the user, or device), 1 foot, 3 feet, etc. Thus, using a reference location that is not exactly the location of the user allows a user to bring cube 406 from the distant location to the user and/or to hand 410 by bringing hand 410 to the reference location that is slightly in front of the user (e.g., without requiring the user to bring hand 410 all the way to the location to the user, which is potentially an awkward gesture).

In some embodiments, the above scaling of the movement of cube 406 is applied to movements both towards and farther away from the user. In some embodiments, the above scaling is applied only to movements towards the user and movements away from the user (e.g., in the z axis) are scaled different (e.g., scaled 1-to-1 with the movement of hand 410). In some embodiments, the above-described scaling is applied to movements in particular directions based on the context and/or type of element being manipulated. For example, if the user is moving a virtual object in a direction that is not intended by the designer of the three-dimensional environment, then the movement of the virtual object can be dampened (e.g., scaled less), but if the user is moving the virtual object in a direction that is intended by the designer, then the movement of the virtual object can be amplified (e.g., scaled more). Thus, the scaling factor can be different based on the direction of movement to provide the user with feedback on whether certain directions of movement are compatible or intended.

It is understood that the movement of virtual objects described above is not limited to only one type of manipulation at a time or movement in one axis at a time. For example, a user is able to move a virtual object (e.g., such as cube 406) in both the x, y directions (e.g., as in FIG. 4B) and the z direction (e.g., changing depth, as in FIG. 4D) while simultaneously rotating the virtual object (e.g., as in FIG. 4C). Thus, the device is able to determine different movement and/or rotation components of hand 410 and perform the appropriate manipulations to a virtual object. For example, if hand 410 moved leftwards while simultaneously moving closer to the user (e.g., while maintaining selection of cube 406), the device can move cube 406 leftwards in a manner described above with respect to FIG. 4B while simultaneously moving cube 406 closer to the user in a manner described with respect to FIG. 4D. Similarly, if hand 410 moved leftwards while simultaneously rotating, the device can move cube 406 leftwards in a manner described above with respect to FIG. 4B while simultaneously rotating cube 406 in a manner described above with respect to FIG. 4C.

Thus, as described above, while performing indirect manipulations, the direction, magnitude, and/or speed of a manipulation can depend on the direction, magnitude, and/or speed of the movement of the hand of the user. For example, while performing a movement manipulation, if the hand of the user moves rightwards, the virtual object being manipulated moves rightwards, if the hand of the user moves leftwards, the virtual object moves leftwards, if the hand of the user moves forwards (e.g., away from the user), the virtual object moves forward (e.g., away from the user), etc. Similarly, if the hand moves quickly, the virtual object optionally moves quickly, and if the hand moves slowly, the virtual object optionally moves slowly. And as described above, the amount of movement depends on the amount of movement of the hand (e.g., optionally scaled based on distance from the user, as described above). In some embodiments, while performing a rotational manipulation, the direction of rotation, magnitude, and/or speed depends on the direction of rotation, magnitude of rotation, and/or speed of the rotation of the hand of the user, in a manner similar to described above for movement manipulations.

FIGS. 5A-5D illustrate a method of directly manipulating a virtual object according to some embodiments of the disclosure. In FIG. 5A, the device is displaying three-dimensional environment 500 (e.g., similar to three-dimensional environments 300 and 400) via a display generation component, including cube 506 on table 502. In some embodiments, cube 506 is a virtual object similar to cube 306 and 406 described above with respect to FIGS. 3 and 4A-4D. Similarly to described above with respect to FIG. 4A, FIG. 5A illustrates cube 506 twice, but it is understood that the second cube 506 that is displayed near the bottom of the figure (e.g., near hand 510) is not displayed in three-dimensional environment 500 and is shown in FIG. 5A for the purpose of illustrating the distance of hand 510 from cube 506 (e.g., on table 502) when performing Gesture A, as will be described in further detail below. In other words, three-dimensional environment 500 does not include two copies of cube 506 (e.g., the second cube 506 near hand 510 is a duplicate of cube 506 on table 502 and is displayed for illustration purposes, and the duplicate is not illustrated in FIGS. 5B-5D).

As discussed above, a direct manipulation is an interaction with a virtual object in which a user uses one or more hands to intersect with a virtual object when manipulating the virtual object. For example, grabbing a virtual object in a manner similar to grabbing a physical object and moving the hand that is grabbing the virtual object is an example of moving the virtual object via direct manipulation. In some embodiments, whether a user is performing a direct manipulation or indirect manipulation operation on a virtual object depends on whether the hand of the user is within a threshold distance from the virtual object being manipulated. For example, if the hand of the user is in contact with the virtual object (e.g., at least a portion of the hand of the user is at a location in physical space such that it appears as if the portion of the hand is contacting or intersecting with the virtual object in the three-dimensional environment), then the user is directly interacting with the virtual object. In some embodiments, a device can interpret a user's interactions as a direct manipulation if the hand of the user is within a threshold distance 512 from a virtual object to be manipulated (e.g., within 1 inch, within 6 inches, within 1 foot, within 3 feet, etc.). In some embodiments, user inputs when hand 510 is within a threshold distance 512 of a virtual object are directed to the virtual object. For example, if hand 510 is within threshold distance 512 of one virtual object, the user's inputs are directed to that virtual object (optionally without regard to whether the gaze of the user is directed to that virtual object). If hand 510 is within threshold distance 512 of two virtual objects, the user's inputs can be directed to the virtual object that is closer or closer to the portion of hand 510 that is performing the inputs (e.g., closer to the pinch location if the selection input is a pinch gesture) or the virtual object that the user's gaze is directed to. If hand 510 is not within threshold distance 512 of any virtual objects, then the device can determine whether the user is performing an indirect manipulation of a virtual object as described above with respect to FIGS. 4A-4D (e.g., if the user's gaze is directed to a particular virtual object).

In FIG. 5A, the device detects that hand 510 is performing a gesture corresponding to a selection input (e.g., “Gesture A”, a pinch gesture, a tap gesture, a poke gesture, etc.) when hand 510 is within threshold distance 512 of cube 506. In some embodiments, in response to hand 510 performing the selection input when within threshold distance 512 of cube 506 (and optionally hand 510 is not within threshold distance 512 of any other virtual object), cube 506 is selected for input such that further user inputs (e.g., object manipulation inputs, etc.) are performed on cube 506. In FIG. 5A, cube 506 is selected for input despite gaze 514 of the user being directed to table 502 when the selection input was performed. Thus, in some embodiments, the user is able to interact with a virtual object without requiring that the user look at the virtual object via direct manipulation of the virtual object.

In FIG. 5B, in response to cube 506 being selected for input, in some embodiments, cube 506 is automatically rotated by a respective amount 516 such that cube 506 is aligned with one or more axes and/or one or more surfaces of an object. For example, the orientation of cube 506 is snapped to the nearest axis such that at least one border of cube 506 is aligned with the x-axis (e.g., perfectly horizontal), the y-axis (e.g., perfectly vertical), or the z-axis (e.g., perfectly flat). In some embodiments, cube 506 is automatically snapped to an upward orientation (e.g., aligned with gravity and/or other objects in the environment). In some embodiments, in response to cube 506 being selected for input, cube 506 snaps to the same orientation as hand 510. For example, if hand 510 is oriented diagonally at a 30 degree angle (e.g., such as shown in FIG. 5B), then cube 506 can be snapped to a 30 degree rotated orientation. In some embodiments, cube 506 does not change orientations in response to being selected for input and maintains the orientation that it had when the selection input was received (e.g., such as in FIG. 5A). In some embodiments, cube 506 is automatically snapped to the orientation of the surface of table 502 (e.g., such that the bottom surface of cube 506 is flush with the top surface of table 502).

FIG. 5C illustrates a method of moving a virtual object in three-dimensional environment 500. In FIG. 5C, while maintaining the selection gesture (e.g., maintaining the pinch gesture, pointing gesture, tapping gesture, etc.), the device detects hand 510 moving rightwards (e.g., in the “x” axis) by a respective amount 518. In response to detecting hand 510 moving rightwards, the device optionally moves cube 506 rightwards by a second respective amount 520. In some embodiments, cube 506 moves by the same amount as hand 510 such that the relative distance and/or relative position between cube 506 and hand 510 is maintained. For example, if cube 506 was 3 inches in front of hand 510 when the selection input was received, then in response to the user input (and optionally while receiving the user input), cube 506 moves with the movement of hand 510 and remains 3 inches in front of hand 510. In some embodiments, the movement of cube 506 in the x and y directions scale 1-to-1 with the movement of hand 510. Thus, in some embodiments, the movement of cube 506 simulates hand 510 physically holding onto and moving cube 506, in which cube 506 moves in the same direction, by the same amount, and at the same speed as the hand 510 (e.g., whereas during indirect manipulation, cube 506 optionally moves more or less than the movement of hand 510, as described above with reference to FIG. 4B). In some embodiments, the movement of cube 506 during direct manipulation does not lock into a respective movement orientation and is able to move in any direction (e.g., 6 degrees of freedom) based on the movement of the hand (e.g., whereas during some embodiments of indirect manipulation, the movement of the virtual object locks into one movement orientation, such as the x, y, or z axis, and movements of the hand in other directions are filtered, ignored, or otherwise do not cause the virtual object to move in those other directions).

FIG. 5D illustrates a method of moving a virtual object toward or away from the user in three-dimensional environment 500. In FIG. 5D, while maintaining the selection gesture (e.g., maintaining the pinch gesture, pointing gesture, tapping gesture, etc.), the device detects hand 510 moving forward (e.g., away from the user and/or device, in the z direction) by a respective amount 522. In response to detecting hand 510 moving farther away, the device optionally moves cube 506 farther away by a second respective amount 524. In some embodiments, cube 506 moves by the same amount as hand 510 such that the relative distance and/or position between cube 506 and hand 510 is maintained. Thus, changes in the distance of cube 506 from the user and/or device (e.g., away from and toward the user) optionally scale 1-to-1 with the movement of hand 510 (e.g., whereas during indirect manipulation, movements towards and/or away from the user optionally do not scale 1-to-1 with the movement of hand 510).

In some embodiments, while performing a direct manipulation of cube 506, a rotation of hand 510 while maintaining the selection gesture causes cube 506 to also rotate in the same way (optionally exhibiting the same or similar behavior as described above with respect to FIG. 4C).

Thus, as illustrated above, when a user is performing a direct manipulation of a virtual object, movements of the virtual object optionally scale 1-to-1 with the movement of the hand that is performing the selection input, but when performing an indirect manipulation of a virtual object, movements of the virtual object do not always scale 1-to-1 with the movement of the hand that is performing the selection input. In some embodiments, rotation inputs scale by the same amount regardless of whether the manipulation is a direct or indirect manipulation. In some embodiments, whether a user is performing a direct manipulation input or an indirect manipulation input is based on whether the hand of the user is within a threshold distance of a virtual object when the selection input (e.g., selection gesture) is received.

Thus, as described above, while performing direct manipulations, the direction, magnitude, and/or speed of a manipulation can depend on the direction, magnitude, and/or speed of the movement of the hand of the user. For example, while performing a movement manipulation, if the hand of the user moves rightwards, the virtual object being manipulated moves rightwards, if the hand of the user moves leftwards, the virtual object moves leftwards, if the hand of the user moves forwards (e.g., away from the user), the virtual object moves forward (e.g., away from the user), etc. Similarly, if the hand moves quickly, the virtual object optionally moves quickly, and if the hand moves slowly, the virtual object optionally moves slowly. And as described above, the amount of movement is scaled 1-to-1 with the amount of movement of the hand (e.g., as opposed to being scaled by distance, as described above in FIGS. 4A-4D). In some embodiments, while performing a rotational manipulation, the direction of rotation, magnitude, and/or speed depends on the direction of rotation, magnitude of rotation, and/or speed of the rotation of the hand of the user, in a manner similar to described above for movement manipulations.

FIGS. 6A-6B illustrate a method of moving a virtual object according to some embodiments of the disclosure. In FIG. 6A, the device is displaying three-dimensional environment 600 (e.g., similar to three-dimensional environments 300, 400, and 500) via a display generation component, including cube 606 on table 602. In some embodiments, cube 606 is a virtual object similar to cube 306, 406, and 506 described above with respect to FIGS. 3, 4A-4D, and 5A-5D. Similarly to described above with respect to FIG. 4A and FIG. 5A, FIG. 6A illustrates cube 606 twice, but it is understood that the second cube 606 that is displayed near the bottom of the figure (e.g., near hand 610) is not displayed in three-dimensional environment 600 and is shown in FIG. 6A for the purpose of illustrating the distance of hand 610 from cube 606 (e.g., on table 602) when performing Gesture B, as will be described in further detail below. In other words, three-dimensional environment 600 does not include two copies of cube 606 (e.g., the second cube 606 near hand 610 is a duplicate of cube 606 on table 602 and is displayed for illustration purposes, and the duplicate is not illustrated in FIG. 6B).

In FIG. 6A, while hand 610 is more than threshold distance 612 from cube 606, the device detects that hand 610 performed a respective gesture (e.g., “Gesture B”). In some embodiments, the respective gesture includes a pinch gesture (e.g., between the thumb and forefinger of the hand, or any two or more fingers of one or more hands, such as described above with respect to “Gesture A”). In some embodiments, the respective gesture includes a pinch gesture followed by a predetermined movement and/or rotation of hand 610 while maintaining the pinch gesture (e.g., Gesture B includes Gesture A, followed by a respective movement by hand 610). For example, a tugging gesture by hand 610 (e.g., an upward rotation of hand 610 such that the fingers and/or pinch location is moved closer and/or rotated towards to the user while the wrist optionally maintains its position). In some embodiments, the respective gesture includes a pinch gesture followed by a movement of hand 610 bringing hand 610 to the location of the user or to a predetermined reference location in front of the user, thus bringing cube 606 from a distant location to the location of hand 610 (e.g., such as described above with reference to FIG. 4D). In some embodiments, the respective gesture corresponds to request to move cube 606 to a location for direct manipulation (e.g., to a location associated with hand 610). In some embodiments, because the respective gesture is an indirect manipulation input (e.g., hand 610 is more than threshold distance 612 from cube 606), the device uses gaze 614 to determine that the user's input is directed to cube 606. It is understood that the respective gesture can be any gesture predetermined to correspond to a request to move cube 606 to a location for direct manipulation (e.g., including, but not limited to, selection of a selectable option to snap cube 606 to the location of hand 610).

In some embodiments, in response to detecting the respective gesture by hand 610 (e.g., Gesture B) while gaze 615 is directed to cube 606, the device moves cube 606 to a location associated with hand 610, as shown in FIG. 6B. In some embodiments, the respective gesture includes a pinch gesture and cube 606 is moved to the location of the pinch (e.g., a portion of cube 606 is located at the location of the pinch such that it appears as if hand 610 is pinching the portion of cube 606) or to a location that is within a predetermined distance from the pinch (e.g., 1 inch, 3 inches, 6 inches, etc.). Thus, after moving cube 606 to the location of the pinch, the user is able to perform direct manipulations to cube 606 by maintaining the pinch gesture (e.g., maintaining the selection input) and performing direct manipulation gestures, similar to those described above with respect to FIGS. 5A-5D (e.g., lateral movements, forward and back movements, rotations, etc.). In some embodiments, moving cube 606 to the location of the pinch allows a user to use direct manipulation inputs to manipulate an object that is at a location in three-dimensional environment 600 that otherwise would be too far away to reach using the hand of the user.

It is understood that while the figures and description above describes movements in particular directions or rotations in particular directions, this is merely exemplary and virtual objects can exhibit the same or similar behavior for movements or rotations in any direction. For example, virtual objects can be moved leftwards and exhibit the same response to the user input as the examples illustrated above for moving the virtual object rightwards. Similarly, virtual objects can be rotated in a counter-clockwise fashion and exhibit the same response to the user input as the example illustrated above for rotating the virtual object in a clockwise fashion.

It is also understood that while the figures and description above describe manipulations of virtual objects, the above-described methods can be applied to any type of user interface element or control elements. For example, a button, a slider, dials, knobs, etc. can be moved or rotated according to the direct or indirect manipulation methods described above.

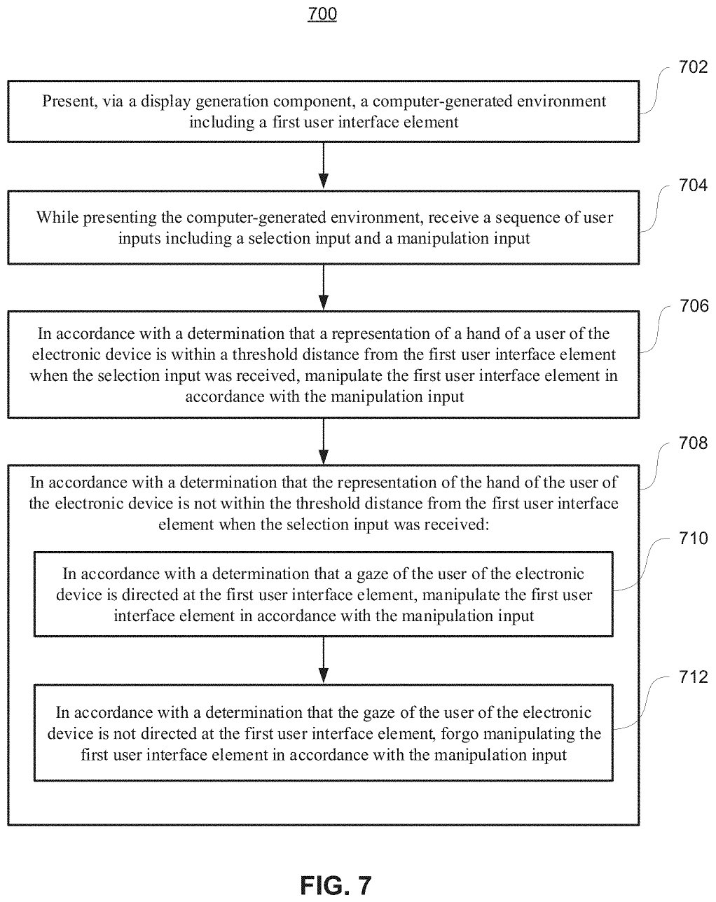

FIG. 7 is a flow diagram illustrating a method 700 of manipulating a virtual object according to some embodiments of the disclosure. The method 700 is optionally performed at an electronic device such as device 100, and device 200 when displaying selectable options on a surface described above with reference to FIGS. 3A-3C, 4A-4B, 5A-5B, and 6A-6B. Some operations in method 700 are, optionally combined (e.g., with each other or with operations in method 800) and/or order of some operations is, optionally, changed. As described below, the method 700 provides methods of manipulating a virtual object in accordance with embodiments of the disclosure (e.g., as discussed above with respect to FIGS. 3-6B).

In some embodiments, an electronic device (e.g., a mobile device (e.g., a tablet, a smartphone, a media player, or a wearable device), a computer, etc. such as device 100 and/or device 200) in communication with a display generation component (e.g., a display integrated with the electronic device (optionally a touch screen display) and/or an external display such as a monitor, projector, television, etc.) and one or more input devices (e.g., a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera (e.g., visible light camera), a depth sensor and/or a motion sensor (e.g., a hand tracking sensor, a hand motion sensor), etc.) presents (702), via the display generation component, a computer-generated environment including a first user interface element, such as three-dimensional environment 300 including cube 306 in FIG. 3.

In some embodiments, while presenting the computer-generated environment, the electronic device receives (704) a plurality (e.g., a sequence) of user inputs including a selection input and a manipulation input, such as hand 410 performing a gesture (e.g., Gesture A) corresponding to a selection input in FIG. 4A and moving hand 410 while maintaining the gesture in FIGS. 4B-4D.

In some embodiments, in accordance with a determination that a representation of a hand of a user of the electronic device is within a threshold distance from the first user interface element when the selection input was received, such as hand 510 within threshold distance 512 from cube 506 in FIG. 5A, the electronic device manipulates (706) the first user interface element in accordance with the manipulation input, such as the movement of cube 506 in accordance with the movement of hand 510 in FIGS. 5C-5D. In some embodiments, manipulating the first user interface includes a movement operation, a rotation operation, a resizing operation, or any other suitable manipulation operation. In some embodiments, the threshold distance is 1 inch, 3 inches, 6 inches, 1 foot, 3 feet, etc.

In some embodiments, in accordance with a determination that the representation of the hand of the user of the electronic device is not within the threshold distance from the first user interface element when the selection input was received (708), such as hand 410 being further than threshold distance 412 from cube 406 in FIG. 4A: in accordance with a determination that a gaze of the user of the electronic device is directed at the first user interface element, the electronic device manipulates (710) the first user interface element in accordance with the manipulation input, such as gaze 408 being directed to cube 406 when hand 410 performed the selection input (e.g., “Gesture A”) in FIG. 4A, and cube 406 being manipulated in accordance with the movement of hand 410 in FIGS. 4B-4D, and in accordance with a determination that the gaze of the user of the electronic device is not directed at the first user interface element, the electronic device forgoes (712) manipulating the first user interface element in accordance with the manipulation input, such as if gaze 408 were not directed to cube 406 when hand 410 performed the selection input, then cube 406 is optionally not manipulated in accordance with the movement of hand 410. In some embodiments, if the gaze were directed to another object when the selection input was received, then the other object is manipulated in accordance with the movement of hand 410. In some embodiments, a non-virtual object is not manipulable, such that if the gaze is directed to an object that is not a virtual object (e.g., a representation or depiction of a real world object), then the non-virtual object is not manipulated in accordance with the movement of hand 410 (e.g., the user input is optionally discarded or ignored, and/or a notification is displayed indicating to the user that the object is not manipulable).

In some embodiments, in accordance with a determination that the representation of the hand of the user of the electronic device is within the threshold distance from a second user interface element when the selection input was received, the electronic device manipulates the second user interface element in accordance with the manipulation input. For example, if the hand of the user is within a threshold distance of any virtual object, the respective virtual object that is closest to the hand and/or closest to the pinch point of the hand is selected for input (e.g., such that subsequent movements of the hand cause a manipulation of the respective virtual object).

In some embodiments, in accordance with a determination that the representation of the hand of the user of the electronic device is not within the threshold distance from the second user interface element when the selection input was received, in accordance with a determination that the gaze of the user of the electronic device is directed at the second user interface element, the electronic device manipulates the second user interface element in accordance with the manipulation input, and in accordance with a determination that the gaze of the user of the electronic device is not directed at the second user interface element, the electronic device forgoes manipulating the second user interface element in accordance with the manipulation input. For example, if the hand of the user is not within the threshold distance of any virtual object, then the object that the gaze of the user is directed to is the object that is selected for input in response to detecting the selection input. In some embodiments, if the gaze is directed to a first virtual object, the first virtual object is selected for manipulation, but if the gaze is directed to a second virtual object, the second virtual object is selected for manipulation. As described herein, the determination of whether the gaze of the user is directed to a particular object or location is based on one or more gaze tracking sensors. In some embodiments, if the gaze of the user is directed to a particular location in the physical world that maps to (e.g., corresponds to) a particular location in the three-dimensional environment, then the gaze of the user is considered to be directed to the corresponding location in the three-dimensional environment (e.g., if a virtual object is at that corresponding location in the three-dimensional environment, then the gaze of the user is interpreted to be directed to that virtual object).

In some embodiments, the manipulation input includes a movement of the hand of the user, such as the horizontal movement of hand 410 in FIG. 4B, and the movement towards the user in FIG. 4D. In some embodiments, in accordance with the determination that the representation of a hand of the user of the electronic device is within the threshold distance from the first user interface element when the selection input was received, manipulating the first user interface element in accordance with the manipulation input includes moving the first user interface element by an amount equal to an amount of the movement of the hand of the user, such as cube 506 moving rightwards by the same amount as the rightward movement of hand 510 in FIG. 5C. In some embodiments, in accordance with the determination that the representation of the hand of the user of the electronic device is not within the threshold distance from the first user interface element when the selection input was received, manipulating the first user interface element in accordance with the manipulation input includes moving the first user interface element by an amount not equal to the amount of the movement of the hand of the user, such as cube 406 moving rightwards by more than the amount of rightward movement of hand 410 in FIG. 4B.

In some embodiments, in response to receiving the selection input and before manipulating the first user interface element in accordance with the manipulation input, the electronic device changes an orientation of the first user interface element based on an orientation of the hand of the user, such as cube 516 snapping to a particular orientation that is optionally based on the orientation of hand 510 in FIG. 5B. In some embodiments, cube 516 is snapped to its “upward” orientation. In some embodiments, cube 516 is snapped to the closest axis. In some embodiments, cube 516 is snapped to the same orientation as hand 510 (e.g., if hand 510 is held diagonally, then cube 516 is snapped to the same diagonal angle).

In some embodiments, the manipulation input includes a rotation of the hand of the user and manipulating the first user interface element in accordance with the manipulation input includes rotating the first user interface element, such as the rotation of cube 406 in accordance with the rotation of hand 410 in FIG. 4C. In some embodiments, the virtual object is rotated in the same direction and the same amount as the rotation of the hand. For example, if the hand rotated in the yaw orientation, then the virtual object rotates in the yaw orientation, and if the hand rotated in the pitch orientation, then the virtual object rotates in the pitch orientation, etc. Similarly, if the hand rotated by 30 degrees, then the virtual object optionally rotates by 30 degrees. In some embodiments, a user is able to perform both rotation and movement manipulations simultaneously by both rotating and moving the user's hand while maintaining the selection input.

In some embodiments, the first user interface element includes a control element, such as a button, a slider, a dial, or any other suitable control element. In some embodiments, in response to manipulating the first user interface element in accordance with the manipulation input, the electronic device performs an operation associated with the control element. For example, a user is able to manipulate a control element in a manner similar to that described above with respect to virtual objects, and manipulating the control element optionally causes one or more functions associated with the control element to be performed. For example, sliding a volume slider can cause the volume to change accordingly, etc.

In some embodiments, in accordance with the determination that the representation of the hand of the user is not within the threshold distance from the first user interface element when the selection input was received, and in accordance with a determination that the plurality of user inputs includes a predetermined gesture by the hand of the user, moving the first user interface element to a location in the computer-generated environment associated with the representation of the hand of the user, such as detecting a predetermined gesture (e.g., “Gesture B”) that corresponds to a request to move cube 606 to a position for direct manipulation (e.g., a remote request to directly manipulate) in FIG. 6A, moving cube 606 towards the user, optionally to or near the location of a pinch by hand 610 in FIG. 6B. Thus, by performing a particular gesture, a user is able to cause an object to move to (e.g., fly towards) the location of the hand (or within a threshold distance of the location of the hand) such that the user is able to perform direct manipulation operations on the object. In this way, a user can directly manipulate the object without resorting to indirect manipulation operations and without requiring the user to walk towards the object. In some embodiments, after completing the manipulation operations, such as after detecting the termination of the selection input (e.g., the termination of the pinch gesture, the termination of Gesture B, and/or detection of another gesture that corresponds to a request to return the virtual object back to its original position), cube 606 is moved back to its original position before the user input (optionally maintaining the manipulations that were performed while being held by the user, such as rotations, etc.). In some embodiments, after completing the manipulation operations, such as after detecting the termination of the selection input, cube 606 remains at the location that it was at when the selection input was terminated (e.g., cube 606 does not move back to its original position, but stays at the position that the user placed it).

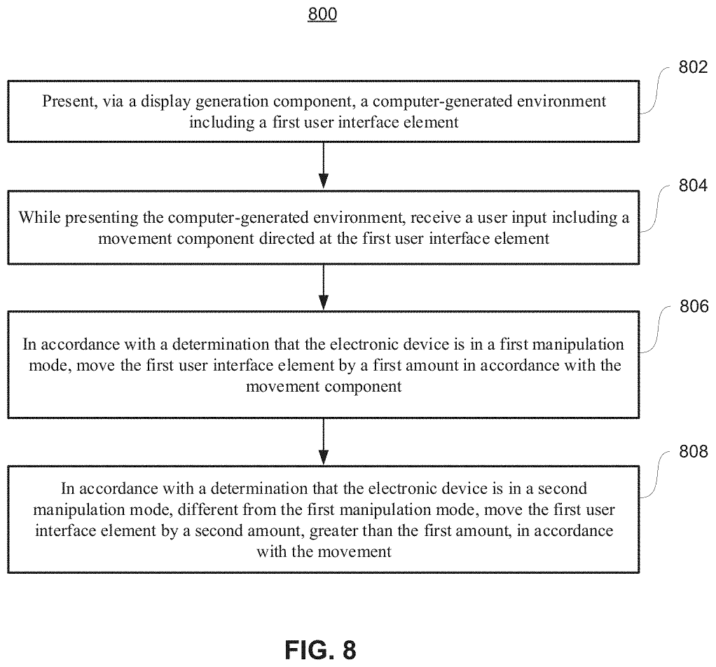

FIG. 8 is a flow diagram illustrating a method 800 of moving a virtual object by an amount based on the distance of the virtual object to the user according to some embodiments of the disclosure. The method 800 is optionally performed at an electronic device such as device 100, and device 200 when displaying selectable options on a surface described above with reference to FIGS. 3A-3C, 4A-4B, 5A-5B, and 6A-6B. Some operations in method 800 are, optionally combined (e.g., with each other or with operations in method 700) and/or order of some operations is, optionally, changed. As described below, the method 800 provides methods of moving a virtual object by an amount based on the distance of the virtual object to the user in accordance with embodiments of the disclosure (e.g., as discussed above with respect to FIGS. 3-6B).

In some embodiments, an electronic device (e.g., a mobile device (e.g., a tablet, a smartphone, a media player, or a wearable device), a computer, etc. such as device 100 and/or device 200) in communication with a display generation component (e.g., a display integrated with the electronic device (optionally a touch screen display) and/or an external display such as a monitor, projector, television, etc.) and one or more input devices (e.g., a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera (e.g., visible light camera), a depth sensor and/or a motion sensor (e.g., a hand tracking sensor, a hand motion sensor), etc.) presents (802), via the display generation component, a computer-generated environment including a first user interface element, such as three-dimensional environment 300 including cube 306 in FIG. 3.

In some embodiments, while presenting the computer-generated environment, the electronic device receives (804) a user input including a movement component directed at the first user interface element, such as the rightward movement of hand 410 in FIG. 4B. In some embodiments, in accordance with a determination that the electronic device is in a first manipulation mode, the electronic device moves (806) the first user interface element by a first amount in accordance with the movement component, such as moving cube 506 by an amount 520 while in direct manipulation mode in FIG. 5C. In some embodiments, in accordance with a determination that the electronic device is in a second manipulation mode, different from the first manipulation mode, the electronic device moves (808) the first user interface element by a second amount, greater than the first amount, in accordance with the movement component, such as moving cube 406 by an amount 418 while in indirect manipulation mode in FIG. 4B.

In some embodiments, the first manipulation mode is a direct manipulation mode, wherein a representation of a hand of a user of the electronic device is within a threshold distance of the first user interface element when the user input was received, such as hand 510 being within threshold distance 512 of cube 506 in FIG. 5A, and the second manipulation mode is an indirect manipulation mode, wherein the representation of the hand of the user is not within the threshold distance of the first user interface element when the user input was received, such as hand 410 being farther than threshold distance 412 of cube 406 in FIG. 4A.

In some embodiments, the first amount is a same amount as a movement of the movement component of the user input, such as in FIG. 5C and the second amount is a different amount than the movement of the movement component of the user input, such as in FIG. 4B.

In some embodiments, the second amount is an amount of a movement of the movement component of the user input scaled by a scaling factor, such as the movement of cube 406 being scaled by a scaling factor that is based on the distance of cube 406 from the user and/or the distance of hand 410 from the user in FIG. 4B.

In some embodiments, in accordance with a determination that the movement of the movement component is in a first direction relative to a user of the electronic device, the scaling factor is a first scaling factor, and in accordance with a determination that the movement of the movement component is in a second direction relative to the user, different from the first direction, the scaling factor is a second scaling factor, different from the first scaling factor. For example, if the object is being moved away from the user, then the scaling factor is optionally not based on the distance of object from the user and/or the distance of hand from the user (e.g., optionally the scaling factor is 1), but if the object is being moved towards the user, then the scaling factor is optionally based on the distance of object from the user and/or the distance of hand from the user (e.g., optionally the scaling factor is greater than 1), such as in FIG. 4D.

In some embodiments, the second scaling factor is based on at least a distance of the first user interface element from a predetermined reference location in the computer-generated environment (e.g., the location in the three-dimensional environment corresponding to the location of the head of a user of the electronic device, the location of the user of the electronic device, the location of the electronic device, 1 inch, 3 inches, 6 inches, 1 foot, 3 feet, in front of any of the foregoing) and a distance of the representation of the hand of the user from the predetermined reference location (e.g., the distance from the location in the three-dimensional environment corresponding to the hand of the user to the corresponding location of the location of the head of a user of the electronic device, the location of the user of the electronic device, the location of the electronic device, 1 inch, 3 inches, 6 inches, 1 foot, 3 feet, in front of any of the foregoing), such as described in FIG. 4B.

In some embodiments, the movement component of the user input includes a lateral movement component parallel to a user of the electronic device (e.g., a horizontal movement and/or a vertical movement while maintaining the same distance from the user), such as in FIG. 4B. In some embodiments, an angle of movement of the second amount with respect to a user of the electronic device is a same as an angle of movement of the lateral movement component of the user input with respect to the user of the electronic device, such as cube 406 being moved rightwards by an amount such that the angle of change 420 is the same as the angle of change 416 in the movement of hand 410 due to the rightward movement of hand 410 by the respective amount 414. Thus, in some embodiments, the scaling factor for lateral movements is proportional to the ratio of the distance of the object from the user to the distance of the hand from the user.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display:
presenting, via the display, a computer-generated environment including a first user interface element;
while presenting the computer-generated environment, receiving a plurality of user inputs including a selection input and a manipulation input;
in accordance with a determination that a hand of a user of the electronic device is within a threshold distance from the first user interface element when the selection input was received, manipulating the first user interface element in accordance with the manipulation input; and
in accordance with a determination that the hand of the user of the electronic device is not within the threshold distance from the first user interface element when the selection input was received:
in accordance with a determination that a gaze of the user of the electronic device is directed at the first user interface element, manipulating the first user interface element in accordance with the manipulation input; and
in accordance with a determination that the gaze of the user of the electronic device is not directed at the first user interface element, forgoing manipulating the first user interface element in accordance with the manipulation input.

2. The method of claim 1, wherein the computer-generated environment includes a second user interface element, and the method further comprising:
in accordance with a determination that the hand of the user of the electronic device is within the threshold distance from the second user interface element when the selection input was received, manipulating the second user interface element in accordance with the manipulation input; and
in accordance with a determination that the hand of the user of the electronic device is not within the threshold distance from the second user interface element when the selection input was received:
in accordance with a determination that the gaze of the user of the electronic device is directed at the second user interface element, manipulating the second user interface element in accordance with the manipulation input; and
in accordance with a determination that the gaze of the user of the electronic device is not directed at the second user interface element, forgoing manipulating the second user interface element in accordance with the manipulation input.

3. The method of claim 1, wherein:
the manipulation input includes a movement of the hand of the user;
in accordance with the determination that the hand of the user of the electronic device is within the threshold distance from the first user interface element when the selection input was received, manipulating the first user interface element in accordance with the manipulation input includes moving the first user interface element by an amount approximately equal to or equal to an amount of the movement of the hand of the user within the computer-generated environment; and
in accordance with the determination that the hand of the user of the electronic device is not within the threshold distance from the first user interface element when the selection input was received, manipulating the first user interface element in accordance with the manipulation input includes moving the first user interface element by an amount not approximately equal to and not equal to the amount of the movement of the hand of the user.

4. The method of claim 1, further comprising:
in response to receiving the selection input and before manipulating the first user interface element in accordance with the manipulation input, changing an orientation of the first user interface element based on an orientation of the hand of the user.

5. The method of claim 1, wherein the manipulation input includes a rotation of the hand of the user and manipulating the first user interface element in accordance with the manipulation input includes rotating the first user interface element.

6. The method of claim 1, wherein the first user interface element includes a control element, the method further comprising:
in response to manipulating the first user interface element in accordance with the manipulation input, performing an operation associated with the control element.

7. The method of claim 1, further comprising:
in accordance with the determination that the hand of the user is not within the threshold distance from the first user interface element when the selection input was received, and in accordance with a determination that the plurality of user inputs includes a predetermined gesture by the hand of the user, moving the first user interface element to a location in the computer-generated environment associated with the hand of the user.

8. An electronic device, comprising:
one or more processors;
memory; and
one or more programs, wherein the one or more programs are stored in the memory and configured to be executed by the one or more processors, the one or more programs including instructions for:
presenting, via a display, a computer-generated environment including a first user interface element;
while presenting the computer-generated environment, receiving a plurality of user inputs including a selection input and a manipulation input;
in accordance with a determination that a hand of a user of the electronic device is within a threshold distance from the first user interface element when the selection input was received, manipulating the first user interface element in accordance with the manipulation input; and
in accordance with a determination that the hand of the user of the electronic device is not within the threshold distance from the first user interface element when the selection input was received:
in accordance with a determination that a gaze of the user of the electronic device is directed at the first user interface element, manipulating the first user interface element in accordance with the manipulation input; and
in accordance with a determination that the gaze of the user of the electronic device is not directed at the first user interface element, forgoing manipulating the first user interface element in accordance with the manipulation input.

9. A non-transitory computer readable storage medium storing one or more programs, the one or more programs comprising instructions, which when executed by one or more processors of an electronic device, cause the electronic device to:
present, via a display, a computer-generated environment including a first user interface element;
while presenting the computer-generated environment, receive a plurality of user inputs including a selection input and a manipulation input;
in accordance with a determination that a hand of a user of the electronic device is within a threshold distance from the first user interface element when the selection input was received, manipulate the first user interface element in accordance with the manipulation input; and
in accordance with a determination that the hand of the user of the electronic device is not within the threshold distance from the first user interface element when the selection input was received:
in accordance with a determination that a gaze of the user of the electronic device is directed at the first user interface element, manipulate the first user interface element in accordance with the manipulation input; and
in accordance with a determination that the gaze of the user of the electronic device is not directed at the first user interface element, forgo manipulating the first user interface element in accordance with the manipulation input.

10-30. (canceled)

31. The electronic device of claim 8, wherein the computer-generated environment includes a second user interface element, and the one or more programs include instructions for:
in accordance with a determination that the hand of the user of the electronic device is within the threshold distance from the second user interface element when the selection input was received, manipulating the second user interface element in accordance with the manipulation input; and
in accordance with a determination that the hand of the user of the electronic device is not within the threshold distance from the second user interface element when the selection input was received:
in accordance with a determination that the gaze of the user of the electronic device is directed at the second user interface element, manipulating the second user interface element in accordance with the manipulation input; and
in accordance with a determination that the gaze of the user of the electronic device is not directed at the second user interface element, forgoing manipulating the second user interface element in accordance with the manipulation input.

32. The electronic device of claim 8, wherein:
the manipulation input includes a movement of the hand of the user;
in accordance with the determination that the hand of the user of the electronic device is within the threshold distance from the first user interface element when the selection input was received, manipulating the first user interface element in accordance with the manipulation input includes moving the first user interface element by an amount approximately equal to or equal to an amount of the movement of the hand of the user within the computer-generated environment; and
in accordance with the determination that the hand of the user of the electronic device is not within the threshold distance from the first user interface element when the selection input was received, manipulating the first user interface element in accordance with the manipulation input includes moving the first user interface element by an amount not approximately equal to and not equal to the amount of the movement of the hand of the user.

33. The electronic device of claim 8, wherein the one or more programs include instructions for:
in response to receiving the selection input and before manipulating the first user interface element in accordance with the manipulation input, changing an orientation of the first user interface element based on an orientation of the hand of the user.

34. The electronic device of claim 8, wherein the manipulation input includes a rotation of the hand of the user and manipulating the first user interface element in accordance with the manipulation input includes rotating the first user interface element.

35. The electronic device of claim 8, wherein the first user interface element includes a control element, the one or more programs include instructions for:
in response to manipulating the first user interface element in accordance with the manipulation input, performing an operation associated with the control element.

36. The electronic device of claim 8, wherein the one or more programs include instructions for:
in accordance with the determination that the hand of the user is not within the threshold distance from the first user interface element when the selection input was received, and in accordance with a determination that the plurality of user inputs includes a predetermined gesture by the hand of the user, moving the first user interface element to a location in the computer-generated environment associated with the hand of the user.

37. The non-transitory computer readable storage medium of claim 9, wherein the computer-generated environment includes a second user interface element, and the instructions, when executed by the one or more processors of the electronic device, cause the electronic device to:
in accordance with a determination that the hand of the user of the electronic device is within the threshold distance from the second user interface element when the selection input was received, manipulate the second user interface element in accordance with the manipulation input; and
in accordance with a determination that the hand of the user of the electronic device is not within the threshold distance from the second user interface element when the selection input was received:
in accordance with a determination that the gaze of the user of the electronic device is directed at the second user interface element, manipulate the second user interface element in accordance with the manipulation input; and
in accordance with a determination that the gaze of the user of the electronic device is not directed at the second user interface element, forgo manipulating the second user interface element in accordance with the manipulation input.

38. The non-transitory computer readable storage medium of claim 9, wherein:
the manipulation input includes a movement of the hand of the user;
in accordance with the determination that the hand of the user of the electronic device is within the threshold distance from the first user interface element when the selection input was received, manipulating the first user interface element in accordance with the manipulation input includes moving the first user interface element by an amount approximately equal to or equal to an amount of the movement of the hand of the user within the computer-generated environment; and
in accordance with the determination that the hand of the user of the electronic device is not within the threshold distance from the first user interface element when the selection input was received, manipulating the first user interface element in accordance with the manipulation input includes moving the first user interface element by an amount not approximately equal to and not equal to the amount of the movement of the hand of the user.

39. The non-transitory computer readable storage medium of claim 9, wherein the instructions, when executed by the one or more processors of the electronic device, cause the electronic device to:
in response to receiving the selection input and before manipulating the first user interface element in accordance with the manipulation input, change an orientation of the first user interface element based on an orientation of the hand of the user.

40. The non-transitory computer readable storage medium of claim 9, wherein the manipulation input includes a rotation of the hand of the user and manipulating the first user interface element in accordance with the manipulation input includes rotating the first user interface element.

41. The non-transitory computer readable storage medium of claim 9, wherein the first user interface element includes a control element, and wherein the instructions, when executed by the one or more processors of the electronic device, cause the electronic device to:
in response to manipulating the first user interface element in accordance with the manipulation input, perform an operation associated with the control element.

42. The non-transitory computer readable storage medium of claim 9, wherein the instructions, when executed by the one or more processors of the electronic device, cause the electronic device to:
in accordance with the determination that the hand of the user is not within the threshold distance from the first user interface element when the selection input was received, and in accordance with a determination that the plurality of user inputs includes a predetermined gesture by the hand of the user, move the first user interface element to a location in the computer-generated environment associated with the hand of the user.
